(19) United States
(12) Patent Application Publication
(10) Pub. No.: US 2024/0152735 A1
(43) Pub. Date: May 9, 2024

(54) System, Method, and Computer Program Product for Anomaly Detection in Multivariate Time Series

(71) Applicant: Visa International Service Association, San Francisco, CA (US)

(72) Inventors: Lan Wang, Sunnyvale, CA (US); Yu-San Lin, San Francisco, CA (US); Yuhang Wu, Santa Clara, CA (US); Huiyuan Chen, San Jose, CA (US); Fei Wang, Fremont, CA (US); Hao Yang, San Jose, CA (US)

(73) Assignee: Visa International Service Association, San Francisco, CA (US)

(21) Appl. No.: 18/280,727

(22) PCT Filed: Jun. 10, 2022
(86) PCT No.: PCT/US22/32984

§ 371 Date: Sep. 7, 2023

Related U.S. Application Data
(60) Provisional application No. 63/209,139, filed on Jun. 10, 2021.

(51) Int. Cl. G06N 3/0464

(52) U.S. Cl. CPC G06N 3/0464

(57) ABSTRACT

Provided is a system for detecting an anomaly in a multivariate time series that includes at least one processor programmed or configured to receive a dataset of a plurality of data instances, wherein each data instance comprises a time series of data points, determine a set of target data instances based on the dataset, determine a set of historical data instances based on the dataset, generate, based on the set of target data instances, a true value matrix, a true frequency matrix, and a true correlation matrix, generate a forecast value matrix, a forecast frequency matrix, and a forecast correlation matrix based on the set of target data instances and the set of historical data instances, determine an amount of forecasting error, and determine whether the amount of forecasting error corresponds to an anomalous event associated with the dataset of data instances. Methods and computer program products are also provided.

### CROSS REFERENCE TO RELATED APPLICATIONS

This application is the United States national phase of International Application No. PCT/US2022/032984 filed Jun. 10, 2022, and claims priority to U.S. Provisional Patent Application No. 63/209,139, filed Jun. 10, 2021, which are incorporated herein by reference in their entirety.

### BACKGROUND

### 1. Technical Field

The present disclosure relates generally to systems, devices, products, apparatus, and methods for anomaly detection and, in one particular embodiment, to a system, product, and method for detecting an anomaly in a multivariate time series.

### 2. Technical Considerations

A multivariate time series may refer to a time series that has more than one time-dependent variable. In some instances, in a multivariate time series, each time-dependent variable may depend not only on that time-dependent variable's past values, which may be analyzed as events, but also has some dependency on other time-dependent variables. The dependency may be used for forecasting future values of the time-dependent variable.

However, when analyzing a multivariate time series, prediction techniques that are based on true values of time-dependent variables in the multivariate time series may not be able to effectively analyze multiple events inside of a time interval. Further, such prediction techniques may not be able to provide an effective explanation on what events led to an anomaly event or determine whether an anomaly took place.

### SUMMARY

Accordingly, provided are improved systems, devices, products, apparatus, and/or methods for detecting an anomaly in a multivariate time series.

According to non-limiting embodiments or aspects, provided is a system for detecting an anomaly in a multivariate time series, the system including at least one processor programmed or configured to: receive a dataset of a plurality of data instances, wherein each data instance comprises a time series of data points; determine a set of target data instances based on the dataset, wherein each target data instance of the set of target data instances is associated with a first time period; determine a set of historical data instances based on the dataset, wherein each historical data instance of the set of historical data instances is associated with a second time period, the second time period is prior to the first time period; generate, based on the set of target data instances, a true value matrix, a true frequency matrix, and a true correlation matrix; generate a forecast value matrix based on the set of target data instances and the set of historical data instances; generate a forecast frequency matrix based on the set of target data instances and the set of historical data instances; generate a forecast correlation matrix based on the set of target data instances and the set of historical data instances; determine an amount of forecasting error, wherein when determining the amount of forecasting error, the at least one processor is programmed or configured to determine the amount of forecasting error between: the forecast value matrix, the forecast frequency matrix, and the forecast correlation matrix, and the true value matrix, the true frequency matrix, and the true correlation matrix; and determine whether the amount of forecasting error corresponds to an anomalous event associated with the dataset of the plurality of data instances. In non-limiting embodiments or aspects, the system further comprises: generating a historical true value matrix based on a number of time series of data points in the set of target data instances and a number of time steps in a target window segment of data points.

In some non-limiting embodiments or aspects, when determining whether the amount of forecasting error corresponds to an anomalous event associated with the dataset of the plurality of data instances, the at least one processor is programmed or configured to determine whether the amount of forecasting error satisfies a threshold value of forecasting error; and determine whether the dataset of the plurality of data instances includes an anomalous event based on determining whether the amount of forecasting error satisfies the threshold value of forecasting error.

In some non-limiting embodiments or aspects, when determining the amount of forecasting error, the at least one processor is programmed or configured to concatenate the true value matrix, the true frequency matrix, and the true correlation matrix to generate a forecasting input matrix; concatenate the forecast value matrix, the forecast frequency matrix, and the forecast correlation matrix to generate a forecasting output matrix and determine the amount of forecasting error based on the forecasting input matrix; and the forecasting output matrix.

In some non-limiting embodiments or aspects, when determining the amount of forecasting error, the at least one processor is programmed or configured to determine a measure of loss associated with a forecasting error mean for batches of input data instances of the dataset of the plurality of data instances based on the forecasting input matrix and the forecasting output matrix; determine a measure of loss associated with a variance of forecasting error for each batch of input data instances of the dataset of the plurality of data instances based on the forecasting input matrix and the forecasting output matrix; and determine the amount of forecasting error based on the measure of loss associated with a forecasting error mean for batches of data instances and the measure of loss associated with the variance of forecasting error for each batch of data instances.

In some non-limiting embodiments or aspects, when generating the true value matrix, the true frequency matrix, and the true correlation matrix, the at least one processor is programmed or configured to generate the true value matrix based on a number of time series of data points in the set of target data instances and a number of time steps in a target window segment of data points; generate the true frequency matrix based on a discrete Fourier transform of the true value matrix; and generate the true correlation matrix based on cosine similarity scores between a plurality of time series of data points of the plurality of data instances.

In some non-limiting embodiments or aspects, the at least one processor is further programmed or configured to generate a historical true value matrix based on a number of time series of data points in the set of target data instances and a number of time steps in a target window segment of data points.

In some non-limiting embodiments or aspects, when generating the forecast value matrix, the at least one processor is programmed or configured to provide the historical true value matrix as an input to a dilated convolutional neural network (CNN) to generate an output of the dilated CNN; and generate the forecast value matrix based on the output of the dilated CNN.

In some non-limiting embodiments or aspects, when generating the forecast frequency matrix, the at least one processor is programmed or configured to generate a sequence of window segments based on the historical true value matrix; generate a plurality of correlation matrices based on cosine similarity scores of the sequence of window segments; provide the plurality of correlation matrices as an input to a convolutional long short-term memory (ConvLSTM) neural network to generate an output of the ConvLSTM neural network; provide the output of the ConvLSTM neural network as an input to an attention mechanism to generate an output of the attention mechanism; and generate the forecast frequency matrix based on the output of the attention mechanism.

In some non-limiting embodiments or aspects, when generating the forecast correlation matrix, the at least one processor is programmed or configured to generate a sequence of window segments based on the historical true value matrix; generate a plurality of frequency matrices based on a discrete Fourier transform of the sequence of window segments; provide the plurality of frequency matrices as an input to a convolutional long short-term memory (ConvLSTM) neural network to generate an output of the ConvLSTM neural network; provide the output of the ConvLSTM neural network as an input to an attention mechanism to generate an output of the attention mechanism; and generate the forecast correlation matrix based on the output of the attention mechanism.

According to non-limiting embodiments or aspects, provided is a method for detecting an anomaly in a multivariate time series, the method including receiving a dataset of a plurality of data instances, wherein each data instance comprises a time series of data points; determining a set of target data instances based on the dataset, wherein each target data instance of the set of target data instances is associated with a first time period; determining a set of historical data instances based on the dataset, wherein each historical data instance of the set of historical data instances is associated with a second time period, the second time period is prior to the first time period; generate, based on the set of target data instances, a true value matrix, a true frequency matrix, and a true correlation matrix; generating a forecast value matrix based on the set of target data instances and the set of historical data instances; generating a forecast frequency matrix based on the set of target data instances and the set of historical data instances; generating a forecast correlation matrix based on the set of target data instances and the set of historical data instances; determining an amount of forecasting error, wherein determining the amount of forecasting error may include determining the amount of forecasting error between the forecast value matrix, the forecast frequency matrix, and the forecast correlation matrix, and the true value matrix, the true frequency matrix, and the true correlation matrix; and determining whether the amount of forecasting error corresponds to an anomalous event associated with the dataset of the plurality of data instances.

In some non-limiting embodiments or aspects, determining whether the amount of forecasting error corresponds to an anomalous event associated with the dataset of the plurality of data instances may include determining whether the amount of forecasting error satisfies a threshold value of forecasting error; and determining whether the dataset of the plurality of data instances includes an anomalous event based on determining whether the amount of forecasting error satisfies the threshold value of forecasting error.

In some non-limiting embodiments or aspects, determining the amount of forecasting error may include concatenating the true value matrix, the true frequency matrix, and the true correlation matrix to generate a forecasting input matrix; concatenating the forecast value matrix, the forecast frequency matrix, and the forecast correlation matrix to generate a forecasting output matrix; and determining the amount of forecasting error based on the forecasting input matrix and the forecasting output matrix.

In some non-limiting embodiments or aspects, determining the amount of forecasting error may include determining a measure of loss associated with a forecasting error mean for batches of input data instances of the dataset of the plurality of data instances based on the forecasting input matrix and the forecasting output matrix; determining a measure of loss associated with a variance of forecasting error for each batch of input data instances of the dataset of the plurality of data instances based on the forecasting input matrix and the forecasting output matrix; and determining the amount of forecasting error based on the measure of loss associated with a forecasting error mean for batches of data instances and the measure of loss associated with the variance of forecasting error for each batch of data instances.

In some non-limiting embodiments or aspects, generating the true value matrix, the true frequency matrix, and the true correlation matrix may include generating the true value matrix based on a number of time series of data points in the set of target data instances and a number of time steps in a target window segment of data points; generating the true frequency matrix based on a discrete Fourier transform of the true value matrix; and generating the true correlation matrix based on cosine similarity scores between a plurality of time series of data points of the plurality of data instances.

In some non-limiting embodiments or aspects, the method may further include generating a historical true value matrix based on a number of time series of data points in the set of target data instances and a number of time steps in a target window segment of data points.

In some non-limiting embodiments or aspects, generating the forecast value matrix may include providing the historical true value matrix as an input to a dilated convolutional neural network (CNN) to generate an output of the dilated CNN; and generating the forecast value matrix based on the output of the dilated CNN.

In some non-limiting embodiments or aspects, generating the forecast frequency matrix may include generating a sequence of window segments based on the historical true value matrix; generating a plurality of correlation matrices based on cosine similarity scores of the sequence of window segments; providing the plurality of correlation matrices as an input to a convolutional long short-term memory (ConvLSTM) neural network to generate an output of the ConvLSTM neural network; providing the output of the ConvLSTM neural network as an input to an attention mechanism to generate an output of the attention mechanism; and generating the forecast frequency matrix based on the output of the attention mechanism.

In some non-limiting embodiments or aspects, generating the forecast correlation matrix may include generating a sequence of window segments based on the historical true value matrix; generating a plurality of frequency matrices based on a discrete Fourier transform of the sequence of window segments; providing the plurality of frequency matrices as an input to a convolutional long short-term memory (ConvLSTM) neural network to generate an output of the ConvLSTM neural network; providing the output of the ConvLSTM neural network as an input to an attention mechanism to generate an output of the attention mechanism; and generating the forecast correlation matrix based on the output of the attention mechanism.

According to non-limiting embodiments or aspects, provided is a computer program product for detecting an anomaly in a multivariate time series, the computer program product including at least one non-transitory computer-readable medium including one or more instructions that, when executed by at least one processor, cause the at least one processor to: receive a dataset of a plurality of data instances, wherein each data instance comprises a time series of data points; determine a set of target data instances based on the dataset, wherein each target data instance of the set of target data instances is associated with a first time period; determine a set of historical data instances based on the dataset, wherein each historical data instance of the set of historical data instances is associated with a second time period, the second time period is prior to the first time period; generate, based on the set of target data instances, a true value matrix, a true frequency matrix, and a true correlation matrix; generate a forecast value matrix based on the set of target data instances and the set of historical data instances; generate a forecast frequency matrix based on the set of target data instances and the set of historical data instances; generate a forecast correlation matrix based on the set of target data instances and the set of historical data instances; determine an amount of forecasting error, wherein when determining the amount of forecasting error, the at least one processor is programmed or configured to determine the amount of forecasting error between: the forecast value matrix, the forecast frequency matrix, and the forecast correlation matrix, and the true value matrix, the true frequency matrix, and the true correlation matrix; and determine whether the amount of forecasting error corresponds to an anomalous event associated with the dataset of the plurality of data instances.

In some non-limiting embodiments or aspects, the one or more instructions that cause the at least one processor to determine whether the amount of forecasting error corresponds to an anomalous event associated with the dataset of the plurality of data instances may cause the at least one processor to determine whether the amount of forecasting error satisfies a threshold value of forecasting error; and determine whether the dataset of the plurality of data instances includes an anomalous event based on determining whether the amount of forecasting error satisfies the threshold value of forecasting error.

In some non-limiting embodiments or aspects, the one or more instructions that cause the at least one processor to determine the amount of forecasting error may cause the at least one processor to concatenate the true value matrix, the true frequency matrix, and the true correlation matrix to generate a forecasting input matrix; concatenate the forecast value matrix, the forecast frequency matrix, and the forecast correlation matrix to generate a forecasting output matrix; and determine the amount of forecasting error based on the forecasting input matrix and the forecasting output matrix.

In some non-limiting embodiments or aspects, the one or more instructions that cause the at least one processor to determine the amount of forecasting error may cause the at least one processor to determine a measure of loss associated with a forecasting error mean for batches of input data instances of the dataset of the plurality of data instances based on the forecasting input matrix and the forecasting output matrix; determine a measure of loss associated with a variance of forecasting error for each batch of input data instances of the dataset of the plurality of data instances based on the forecasting input matrix and the forecasting output matrix; and determine the amount of forecasting error based on the measure of loss associated with a forecasting error mean for batches of data instances and the measure of loss associated with the variance of forecasting error for each batch of data instances.

In some non-limiting embodiments or aspects, the one or more instructions that cause the at least one processor to generate the true value matrix, the true frequency matrix, and the true correlation matrix may cause the at least one processor to generate the true value matrix based on a number of time series of data points in the set of target data instances and a number of time steps in a target window segment of data points; generate the true frequency matrix based on a discrete Fourier transform of the true value matrix; and generate the true correlation matrix based on cosine similarity scores between a plurality of time series of data points of the plurality of data instances.

In some non-limiting embodiments or aspects, the one or more instructions may further cause the at least one processor to generate a historical true value matrix based on a number of time series of data points in the set of target data instances and a number of time steps in a target window segment of data points.

In some non-limiting embodiments or aspects, the one or more instructions that cause the at least one processor to generate the forecast value matrix may cause the at least one processor to provide the historical true value matrix as an input to a dilated convolutional neural network (CNN) to generate an output of the dilated CNN; and generate the forecast value matrix based on the output of the dilated CNN.

In some non-limiting embodiments or aspects, the one or more instructions that cause the at least one processor to generate the forecast frequency matrix may cause the at least one processor to generate a sequence of window segments based on the historical true value matrix; generate a plurality of correlation matrices based on cosine similarity scores of the sequence of window segments; provide the plurality of correlation matrices as an input to a convolutional long short-term memory (ConvLSTM) neural network to generate an output of the ConvLSTM neural network; provide the output of the ConvLSTM neural network as an input to an attention mechanism to generate an output of the attention mechanism; and generate the forecast frequency matrix based on the output of the attention mechanism.

In some non-limiting embodiments or aspects, the one or more instructions that cause the at least one processor to generate the forecast correlation matrix may cause the at least one processor to generate a sequence of window segments based on the historical true value matrix; generate a plurality of frequency matrices based on a discrete Fourier transform of the sequence of window segments; provide the plurality of frequency matrices as an input to a convolutional long short-term memory (ConvLSTM) neural network to generate an output of the ConvLSTM neural network; provide the output of the ConvLSTM neural network as an input to an attention mechanism to generate an output of the attention mechanism; and generate the forecast correlation matrix based on the output of the attention mechanism.

Further non-limiting embodiments or aspects are set forth in the following numbered clauses:

Clause 1: A system for detecting an anomaly in a multivariate time series, the system comprising: at least one processor programmed or configured to: receive a dataset of a plurality of data instances, wherein each data instance comprises a time series of data points; determine a set of target data instances based on the dataset, wherein each target data instance of the set of target data instances is associated with a first time period; determine a set of historical data instances based on the dataset, wherein each historical data instance of the set of historical data instances is associated with a second time period, wherein the second time period is prior to the first time period; generate, based on the set of target data instances, a true value matrix, a true frequency matrix, and a true correlation matrix; generate a forecast value matrix based on the set of target data instances and the set of historical data instances; generate a forecast frequency matrix based on the set of target data instances and the set of historical data instances; generate a forecast correlation matrix based on the set of target data instances and the set of historical data instances; determine an amount of forecasting error, wherein when determining the amount of forecasting error, the at least one processor is programmed or configured to determine the amount of forecasting error between: the forecast value matrix, the forecast frequency matrix, and the forecast correlation matrix, and the true value matrix, the true frequency matrix, and the true correlation matrix; and determine whether the amount of forecasting error corresponds to an anomalous event associated with the dataset of the plurality of data instances.

Clause 2: The system of clause 1, wherein, when determining whether the amount of forecasting error corresponds to an anomalous event associated with the dataset of the plurality of data instances, the at least one processor is programmed or configured to: determine whether the amount of forecasting error satisfies a threshold value of forecasting error; and determine whether the dataset of the plurality of data instances includes an anomalous event based on determining whether the amount of forecasting error satisfies the threshold value of forecasting error.

Clause 3: The system of clauses 1 or 2, wherein when determining the amount of forecasting error, the at least one processor is programmed or configured to: concatenate the true value matrix, the true frequency matrix, and the true correlation matrix to generate a forecasting input matrix; concatenate the forecast value matrix, the forecast frequency matrix, and the forecast correlation matrix to generate a forecasting output matrix; and determine the amount of forecasting error based on the forecasting input matrix and the forecasting output matrix.

Clause 4: The system of any of clauses 1-3, wherein when determining the amount of forecasting error, the at least one processor is programmed or configured to: determine a measure of loss associated with a forecasting error mean for batches of input data instances of the dataset of the plurality of data instances based on the forecasting input matrix and the forecasting output matrix; determine a measure of loss associated with a variance of forecasting error for each batch of input data instances of the dataset of the plurality of data instances based on the forecasting input matrix and the forecasting output matrix; and determine the amount of forecasting error based on the measure of loss associated with a forecasting error mean for batches of data instances and the measure of loss associated with the variance of forecasting error for each batch of data instances.

Clause 5: The system of any of clauses 1-4, wherein, when generating the true value matrix, the true frequency matrix, and the true correlation matrix, the at least one processor is programmed or configured to: generate the true value matrix based on a number of time series of data points in the set of target data instances and a number of time steps in a target window segment of data points; generate the true frequency matrix based on a discrete Fourier transform of the true value matrix; and generate the true correlation matrix based on cosine similarity scores between a plurality of time series of data points of the plurality of data instances.

Clause 6: The system of any of clauses 1-5, wherein the at least one processor is further programmed or configured to: generate a historical true value matrix based on a number of time series of data points in the set of target data instances and a number of time steps in a target window segment of data points.

Clause 7: The system of any of clauses 1-6, wherein, when generating the forecast value matrix, the at least one processor is programmed or configured to: provide the historical true value matrix as an input to a dilated convolutional neural network (CNN) to generate an output of the dilated CNN; and generate the forecast value matrix based on the output of the dilated CNN.

Clause 8: The system of any of clauses 1-7, wherein, when generating the forecast frequency matrix, the at least one processor is programmed or configured to: generate a sequence of window segments based on the historical true value matrix; generate a plurality of correlation matrices based on cosine similarity scores of the sequence of window segments; provide the plurality of correlation matrices as an input to a convolutional long short-term memory (ConvLSTM) neural network to generate an output of the ConvLSTM neural network; provide the output of the ConvLSTM neural network as an input to an attention mechanism to generate an output of the attention mechanism; and generate the forecast frequency matrix based on the output of the attention mechanism.

Clause 9: The system of any of clauses 1-8, wherein, when generating the forecast correlation matrix, the at least one processor is programmed or configured to: generate a sequence of window segments based on the historical true value matrix; generate a plurality of frequency matrices based on a discrete Fourier transform of the sequence of window segments; provide the plurality of frequency matrices as an input to a convolutional long short-term memory (ConvLSTM) neural network to generate an output of the ConvLSTM neural network; provide the output of the ConvLSTM neural network as an input to an attention mechanism to generate an output of the attention mechanism; and generate the forecast correlation matrix based on the output of the attention mechanism.

Clause 10: A method for detecting an anomaly in a multivariate time series, the method comprising: receiving, with at least one processor, a dataset of a plurality of data instances, wherein each data instance comprises a time series of data points; determining, with the at least one processor, a set of target data instances based on the dataset, wherein each target data instance of the set of target data instances is associated with a first time period; determining, with the at least one processor, a set of historical data instances based on the dataset, wherein each historical data instance of the set of historical data instances is associated with a second time period, wherein the second time period is prior to the first time period; generating, with the at least one processor and based on the set of target data instances, a true value matrix, a true frequency matrix, and a true correlation matrix; generating, with the at least one processor, a forecast value matrix based on the set of target data instances and the set of historical data instances; generating, with the at least one processor, a forecast frequency matrix based on the set of target data instances and the set of historical data instances; generating, with the at least one processor, a forecast correlation matrix based on the set of target data instances and the set of historical data instances; determining, with the at least one processor, an amount of forecasting error, wherein determining the amount of forecasting error comprises determining the amount of forecasting error between: the forecast value matrix, the forecast frequency matrix, and the forecast correlation matrix, and the true value matrix, the true frequency matrix, and the true correlation matrix; and determining, with the at least one processor, whether the amount of forecasting error corresponds to an anomalous event associated with the dataset of the plurality of data instances.

Clause 11: The method of clause 10, wherein determining whether the amount of forecasting error corresponds to an anomalous event associated with the dataset of the plurality of data instances comprises: determining whether the amount of forecasting error satisfies a threshold value of forecasting error; and determining whether the dataset of the plurality of data instances includes an anomalous event based on determining whether the amount of forecasting error satisfies the threshold value of forecasting error.

Clause 12: The method of clauses 10 or 11, wherein determining the amount of forecasting error comprises: concatenating the true value matrix, the true frequency matrix, and the true correlation matrix to generate a forecasting input matrix; concatenating the forecast value matrix, the forecast frequency matrix, and the forecast correlation matrix to generate a forecasting output matrix; and determining the amount of forecasting error based on the forecasting input matrix and the forecasting output matrix.

Clause 13: The method of any of clauses 10-12, wherein determining the amount of forecasting error comprises: determining a measure of loss associated with a forecasting error mean for batches of input data instances of the dataset of the plurality of data instances based on the forecasting input matrix and the forecasting output matrix; determining a measure of loss associated with a variance of forecasting error for each batch of input data instances of the dataset of the plurality of data instances based on the forecasting input matrix and the forecasting output matrix; and determining the amount of forecasting error based on the measure of loss associated with a forecasting error mean for batches of data instances and the measure of loss associated with the variance of forecasting error for each batch of data instances.

Clause 14: The method of any of clauses 10-13, wherein generating the true value matrix, the true frequency matrix, and the true correlation matrix comprises: generating the true value matrix based on a number of time series of data points in the set of target data instances and a number of time steps in a target window segment of data points; generating the true frequency matrix based on a discrete Fourier transform of the true value matrix; and generating the true correlation matrix based on cosine similarity scores between a plurality of time series of data points of the plurality of data instances.

Clause 15: The method of any of clauses 10-14, further comprising: generating a historical true value matrix based on a number of time series of data points in the set of target data instances and a number of time steps in a target window segment of data points.

Clause 16: The method of any of clauses 10-15, wherein generating the forecast value matrix comprises: providing the historical true value matrix as an input to a dilated convolutional neural network (CNN) to generate an output of the dilated CNN; and generating the forecast value matrix based on the output of the dilated CNN.

Clause 17: The method of any of clauses 10-16, wherein generating the forecast frequency matrix comprises: generating a sequence of window segments based on the historical true value matrix; generating a plurality of correlation matrices based on cosine similarity scores of the sequence of window segments; providing the plurality of correlation matrices as an input to a convolutional long short-term memory (ConvLSTM) neural network to generate an output of the ConvLSTM neural network; providing the output of the ConvLSTM neural network as an input to an attention mechanism to generate an output of the attention mechanism; and generating the forecast frequency matrix based on the output of the attention mechanism.

Clause 18: The method of any of clauses 10-17, wherein generating the forecast correlation matrix comprises: generating a sequence of window segments based on the historical true value matrix; generating a plurality of frequency matrices based on a discrete Fourier transform of the sequence of window segments; providing the plurality of frequency matrices as an input to a convolutional long short-term memory (ConvLSTM) neural network to generate an output of the ConvLSTM neural network; providing the output of the ConvLSTM neural network as an input to an attention mechanism to generate an output of the attention mechanism; and generating the forecast correlation matrix based on the output of the attention mechanism.

Clause 19: A computer program product for detecting an anomaly in a multivariate time series, the computer program product comprising at least one non-transitory computer-readable medium including one or more instructions that, when executed by at least one processor, cause the at least one processor to: receive a dataset of a plurality of data instances, wherein each data instance comprises a time series of data points; determine a set of target data instances based on the dataset, wherein each target data instance of the set of target data instances is associated with a first time period; determine a set of historical data instances based on the dataset, wherein each historical data instance of the set of historical data instances is associated with a second time period, wherein the second time period is prior to the first time period; generate, based on the set of target data instances, a true value matrix, a true frequency matrix, and a true correlation matrix; generate a forecast value matrix based on the set of target data instances and the set of historical data instances; generate a forecast frequency matrix based on the set of target data instances and the set of historical data instances; generate a forecast correlation matrix based on the set of target data instances and the set of historical data instances; determine an amount of forecasting error, wherein when determining the amount of forecasting error, the at least one processor is programmed or configured to determine the amount of forecasting error between: the forecast value matrix, the forecast frequency matrix, and the forecast correlation matrix, and the true value matrix, the true frequency matrix, and the true correlation matrix; and determine whether the amount of forecasting error corresponds to an anomalous event associated with the dataset of the plurality of data instances.

Clause 20: The computer program product of clause 19, wherein the one or more instructions that cause the at least one processor to determine whether the amount of forecasting error corresponds to an anomalous event associated with the dataset of the plurality of data instances cause the at least one processor to: determine whether the amount of forecasting error satisfies a threshold value of forecasting error; and determine whether the dataset of the plurality of data instances includes an anomalous event based on determining whether the amount of forecasting error satisfies the threshold value of forecasting error.

Clause 21: The computer program product of clauses 19 or 20, wherein the one or more instructions that cause the at least one processor to determine the amount of forecasting error cause the at least one processor to: concatenate the true value matrix, the true frequency matrix, and the true correlation matrix to generate a forecasting input matrix; concatenate the forecast value matrix, the forecast frequency matrix, and the forecast correlation matrix to generate a forecasting output matrix; and determine the amount of forecasting error based on the forecasting input matrix and the forecasting output matrix.

Clause 22: The computer program product of any of clauses 19-21, wherein the one or more instructions that cause the at least one processor to determine the amount of forecasting error cause the at least one processor to: determine a measure of loss associated with a forecasting error mean for batches of input data instances of the dataset of the plurality of data instances based on the forecasting input matrix and the forecasting output matrix; determine a measure of loss associated with a variance of forecasting error for each batch of input data instances of the dataset of the plurality of data instances based on the forecasting input matrix and the forecasting output matrix; and determine the amount of forecasting error based on the measure of loss associated with a forecasting error mean for batches of data instances and the measure of loss associated with the variance of forecasting error for each batch of data instances.

Clause 23: The computer program product of any of clauses 19-22, wherein the one or more instructions that cause the at least one processor to generate the true value matrix, the true frequency matrix, and the true correlation matrix cause the at least one processor to: generate the true value matrix based on a number of time series of data points in the set of target data instances and a number of time steps in a target window segment of data points; generate the true frequency matrix based on a discrete Fourier transform of the true value matrix; and generate the true correlation matrix based on cosine similarity scores between a plurality of time series of data points of the plurality of data instances.

Clause 24: The computer program product of any of clauses 19-23, wherein the one or more instructions further cause the at least one processor to: generate a historical true value matrix based on a number of time series of data points in the set of target data instances and a number of time steps in a target window segment of data points.

Clause 25: The computer program product of any of clauses 19-24, wherein the one or more instructions that cause the at least one processor to generate the forecast value matrix cause the at least one processor to: provide the historical true value matrix as an input to a dilated convolutional neural network (CNN) to generate an output of the dilated CNN; and generate the forecast value matrix based on the output of the dilated CNN.

Clause 26: The computer program product of any of clauses 19-25, wherein the one or more instructions that cause the at least one processor to generate the forecast frequency matrix cause the at least one processor to: generate a sequence of window segments based on the historical true value matrix; generate a plurality of correlation matrices based on cosine similarity scores of the sequence of window segments; provide the plurality of correlation matrices as an input to a convolutional long short-term memory (ConvLSTM) neural network to generate an output of the ConvLSTM neural network; provide the output of the ConvLSTM neural network as an input to an attention mechanism to generate an output of the attention mechanism; and generate the forecast frequency matrix based on the output of the attention mechanism.

Clause 27: The computer program product of any of clauses 19-26, wherein the one or more instructions that cause the at least one processor to generate the forecast correlation matrix cause the at least one processor to: generate a sequence of window segments based on the historical true value matrix; generate a plurality of frequency matrices based on a discrete Fourier transform of the sequence of window segments; provide the plurality of frequency matrices as an input to a convolutional long short-term memory (ConvLSTM) neural network to generate an output of the ConvLSTM neural network; provide the output of the ConvLSTM neural network as an input to an attention mechanism to generate an output of the attention mechanism; and generate the forecast correlation matrix based on the output of the attention mechanism.

These and other features and characteristics of the present disclosure, as well as the methods of operation and functions of the related elements of structures and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the present disclosure. As used in the specification and the claims, the singular form of “a,” “an,” and “the” include plural referents unless the context clearly dictates otherwise.

### BRIEF DESCRIPTION OF THE DRAWINGS

Additional advantages and details of the present disclosure are explained in greater detail below with reference to the exemplary embodiments that are illustrated in the accompanying schematic figures, in which:

FIG. 1 is a diagram of a non-limiting embodiment or aspect of an environment in which systems, devices, products, apparatus, and/or methods, described herein, may be implemented according to the principles of the present disclosure;

FIG. 2 is a diagram of a non-limiting embodiment or aspect of components of one or more devices of FIG. 1;

FIG. 3 is a flowchart of a non-limiting embodiment or aspect of a process for detecting an anomaly in a multivariate time series;

FIGS. 4A-4I are diagrams of non-limiting embodiments or aspects of an implementation of a process for detecting an anomaly in a multivariate time series; and

FIG. 5 is a diagram of a non-limiting embodiment or aspect of an implementation in which systems, devices, products, apparatus, and/or methods, described herein, may be implemented according to the principles of the present disclosure.

### DETAILED DESCRIPTION

For purposes of the description hereinafter, the terms “end,” “upper,” “lower,” “right,” “left,” “vertical,” “horizontal,” “top,” “bottom,” “lateral,” “longitudinal,” and derivatives thereof shall relate to the disclosure as it is oriented in the drawing figures. However, it is to be understood that the disclosure may assume various alternative variations and step sequences, except where expressly specified to the contrary. It is also to be understood that the specific devices and processes illustrated in the attached drawings, and described in the following specification, are simply exemplary embodiments or aspects of the disclosure. Hence, specific dimensions and other physical characteristics related to the embodiments or aspects of the embodiments disclosed herein are not to be considered as limiting unless otherwise indicated.

No aspect, component, element, structure, act, step, function, instruction, and/or the like used herein should be construed as critical or essential unless explicitly described as such. In addition, as used herein, the articles “a” and “an” are intended to include one or more items and may be used interchangeably with “one or more” and “at least one.” Furthermore, as used herein, the term “set” is intended to include one or more items (e.g., related items, unrelated items, a combination of related and unrelated items, etc.) and may be used interchangeably with “one or more” or “at least one.” Where only one item is intended, the term “one” or similar language is used. Also, as used herein, the terms “has,” “have,” “having,” or the like are intended to be open-ended terms. Further, the phrase “based on” is intended to mean “based at least partially on” unless explicitly stated otherwise. The phase “based on” may also mean “in response to” where appropriate.

As used herein, the terms “communication” and “communicate” may refer to the reception, receipt, transmission, transfer, provision, and/or the like of information (e.g., data, signals, messages, instructions, commands, and/or the like). For one unit (e.g., a device, a system, a component of a device or system, combinations thereof, and/or the like) to be in communication with another unit means that the one unit is able to directly or indirectly receive information from and/or send (e.g., transmit) information to the other unit. This may refer to a direct or indirect connection that is wired and/or wireless in nature. Additionally, two units may be in communication with each other even though the information transmitted may be modified, processed, relayed, and/or routed between the first and second unit. For example, a first unit may be in communication with a second unit even though the first unit passively receives information and does not actively transmit information to the second unit. As another example, a first unit may be in communication with a second unit if at least one intermediary unit (e.g., a third unit located between the first unit and the second unit) processes information received from the first unit and transmits the processed information to the second unit. In some non-limiting embodiments, a message may refer to a network packet (e.g., a data packet and/or the like) that includes data.

As used herein, the terms “issuer,” “issuer institution,” “issuer bank,” or “payment device issuer,” may refer to one or more entities that provide accounts to individuals (e.g., users, customers, and/or the like) for conducting payment transactions, such as credit payment transactions and/or debit payment transactions. For example, an issuer institution may provide an account identifier, such as a primary account number (PAN), to a customer that uniquely identifies one or more accounts associated with that customer. In some non-limiting embodiments, an issuer may be associated with a bank identification number (BIN) that uniquely identifies the issuer institution. As used herein, the term “issuer system” may refer to one or more computer systems operated by or on behalf of an issuer, such as a server executing one or more software applications. For example, an issuer system may include one or more authorization servers for authorizing a transaction.

As used herein, the term “transaction service provider” may refer to an entity that receives transaction authorization requests from merchants or other entities and provides guarantees of payment, in some cases through an agreement between the transaction service provider and an issuer institution. For example, a transaction service provider may include a payment network such as Visa®, MasterCard®, American Express®, or any other entity that processes transactions. As used herein, the term “transaction service provider system” may refer to one or more computer systems operated by or on behalf of a transaction service provider, such as a transaction service provider system executing one or more software applications. A transaction service provider system may include one or more processors and, in some non-limiting embodiments or aspects, may be operated by or on behalf of a transaction service provider.

As used herein, the term “merchant” may refer to one or more entities (e.g., operators of retail businesses) that provide goods and/or services, and/or access to goods and/or services, to a user (e.g., a customer, a consumer, and/or the like) based on a transaction, such as a payment transaction. As used herein, the term “merchant system” may refer to one or more computer systems operated by or on behalf of a merchant, such as a server executing one or more software applications. As used herein, the term “product” may refer to one or more goods and/or services offered by a merchant.

As used herein, the term “acquirer” may refer to an entity licensed by the transaction service provider and approved by the transaction service provider to originate transactions (e.g., payment transactions) involving a payment device associated with the transaction service provider. As used herein, the term “acquirer system” may also refer to one or more computer systems, computer devices, and/or the like operated by or on behalf of an acquirer. The transactions the acquirer may originate may include payment transactions (e.g., purchases, original credit transactions (OCTs), account funding transactions (AFTs), and/or the like). In some non-limiting embodiments, the acquirer may be authorized by the transaction service provider to assign merchant or service providers to originate transactions involving a payment device associated with the transaction service provider. The acquirer may contract with payment facilitators to enable the payment facilitators to sponsor merchants. The acquirer may monitor compliance of the payment facilitators in accordance with regulations of the transaction service provider. The acquirer may conduct due diligence of the payment facilitators and ensure proper due diligence occurs before signing a sponsored merchant. The acquirer may be liable for all transaction service provider programs that the acquirer operates or sponsors. The acquirer may be responsible for the acts of the acquirer's payment facilitators, merchants that are sponsored by the acquirer's payment facilitators, and/or the like. In some non-limiting embodiments, an acquirer may be a financial institution, such as a bank.

As used herein, the term “payment gateway” may refer to an entity and/or a payment processing system operated by or on behalf of such an entity (e.g., a merchant service provider, a payment service provider, a payment facilitator, a payment facilitator that contracts with an acquirer, a payment aggregator, and/or the like), which provides payment services (e.g., transaction service provider payment services, payment processing services, and/or the like) to one or more merchants. The payment services may be associated with the use of portable financial devices managed by a transaction service provider. As used herein, the term “payment gateway system” may refer to one or more computer systems, computer devices, servers, groups of servers, and/or the like operated by or on behalf of a payment gateway.

As used herein, the terms “client” and “client device” may refer to one or more computing devices, such as processors, storage devices, and/or similar computer components, that access a service made available by a server. In some non-limiting embodiments, a client device may include a computing device configured to communicate with one or more networks and/or facilitate transactions such as, but not limited to, one or more desktop computers, one or more portable computers (e.g., tablet computers), one or more mobile devices (e.g., cellular phones, smartphones, personal digital assistant, wearable devices, such as watches, glasses, lenses, and/or clothing, and/or the like), and/or other like devices. Moreover, the term “client” may also refer to an entity that owns, utilizes, and/or operates a client device for facilitating transactions with another entity.

As used herein, the term “server” may refer to one or more computing devices, such as processors, storage devices, and/or similar computer components that communicate with client devices and/or other computing devices over a network, such as the Internet or private networks and, in some examples, facilitate communication among other servers and/or client devices.

As used herein, the term “system” may refer to one or more computing devices or combinations of computing devices such as, but not limited to, processors, servers, client devices, software applications, and/or other like components. In addition, reference to “a server” or “a processor,” as used herein, may refer to a previously-recited server and/or processor that is recited as performing a previous step or function, a different server and/or processor, and/or a combination of servers and/or processors. For example, as used in the specification and the claims, a first server and/or a first processor that is recited as performing a first step or function may refer to the same or different server and/or a processor recited as performing a second step or function.

Non-limiting embodiments or aspects of the present disclosure are directed to systems, methods, and computer program products for detecting an anomaly in a multivariate time series. In some non-limiting embodiments or aspects, an anomaly detection system may include at least one processor programmed or configured to detect an anomaly in a multivariate time series, the system comprising: at least one processor programmed or configured to: receive a dataset of a plurality of data instances, wherein each data instance comprises a time series of data points; determine a set of target data instances based on the dataset, wherein each target data instance of the set of target data instances is associated with a first time period; determine a set of historical data instances based on the dataset, wherein each historical data instance of the set of historical data instances is associated with a second time period, wherein the second time period is prior to the first time period; generate, based on the set of target data instances, a true value matrix, a true frequency matrix, and a true correlation matrix; generate a forecast value matrix based on the set of target data instances and the set of historical data instances; generate a forecast frequency matrix based on the set of target data instances and the set of historical data instances; generate a forecast correlation matrix based on the set of target data instances and the set of historical data instances; determine an amount of forecasting error, wherein when determining the amount of forecasting error, the at least one processor is programmed or configured to determine the amount of forecasting error between: the forecast value matrix, the forecast frequency matrix, and the forecast correlation matrix, and the true value matrix, the true frequency matrix, and the true correlation matrix; and determine whether the amount of forecasting error corresponds to an anomalous event associated with the dataset of the plurality of data instances.

In this way, the anomaly detection system may provide for accurately analyzing multiple events of a multivariate time series inside of a time interval and provide the ability to learn events that led to an anomaly event. Furthermore, the anomaly detection system may provide the ability to accurately determine whether an anomaly event took place in a time series. In non-limiting embodiments or aspects, the anomaly detection system may achieve an improvement in an F-score (e.g., a score measuring the accuracy of precision and recall of a machine learning model) of 17% or higher. Non-limiting embodiments may provide improved generalization and may be more sensitive to different anomalies by using a loss function that involves the forecasting error and a compactness value (e.g., variance). Non-limiting embodiments may provide for improved detection of anomalies (e.g., anomalous events) by using unsupervised and forecast-based machine learning models.

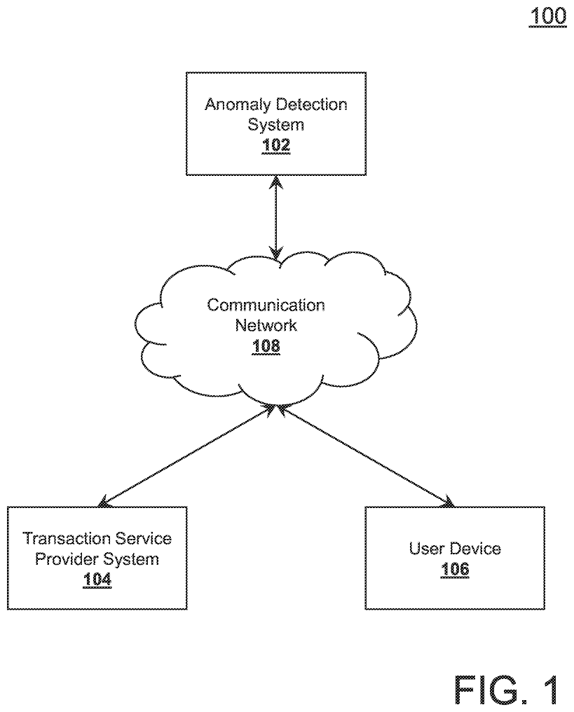

Referring now to FIG. 1, FIG. 1 is a diagram of an example environment 100 in which devices, systems, and/or methods, described herein, may be implemented. As shown in FIG. 1, environment 100 may include anomaly detection system 102, transaction service provider system 104, user device 106, and communication network 108. Anomaly detection system 102, transaction service provider system 104, and/or user device 106 may interconnect (e.g., establish a connection to communicate) via wired connections, wireless connections, or a combination of wired and wireless connections.

Anomaly detection system 102 may include one or more devices configured to communicate with transaction service provider system 104 and/or user device 106 via communication network 108. For example, anomaly detection system 102 may include a server, a group of servers, and/or other like devices. In some non-limiting embodiments or aspects, anomaly detection system 102 may be associated with a transaction service provider system, as described herein. Additionally or alternatively, anomaly detection system 102 may generate (e.g., train, validate, retrain, and/or the like), store, and/or implement (e.g., operate, provide inputs to and/or outputs from, and/or the like) one or more machine learning models. For example, anomaly detection system 102 may generate one or more machine learning models by fitting (e.g., validating) one or machine learning models against data used for training (e.g., training data). In some non-limiting embodiments or aspects, anomaly detection system 102 may generate, store, and/or implement one or more unsupervised machine learning models. In some non-limiting embodiments or aspects, anomaly detection system 102 may be in communication with a data storage device, which may be local or remote to anomaly detection system 102. In some non-limiting embodiments or aspects, anomaly detection system 102 may be capable of receiving information from, storing information in, transmitting information to, and/or searching information stored in the data storage device.

Transaction service provider system 104 may include one or more devices configured to communicate with anomaly detection system 102 and/or user device 106 via communication network 108. For example, transaction service provider system 104 may include a computing device, such as a server, a group of servers, and/or other like devices. In some non-limiting embodiments or aspects, transaction service provider system 104 may be associated with a transaction service provider system as discussed herein. In some non-limiting embodiments or aspects, anomaly detection system 102 may be a component of transaction service provider system 104.

User device 106 may include a computing device configured to communicate with anomaly detection system 102 and/or transaction service provider system 104 via communication network 108. For example, user device 106 may include a computing device, such as a desktop computer, a portable computer (e.g., tablet computer, a laptop computer, and/or the like), a mobile device (e.g., a cellular phone, a smartphone, a personal digital assistant, a wearable device, and/or the like), and/or other like devices. In some non-limiting embodiments or aspects, user device 106 may be associated with a user (e.g., an individual operating user device 106).

Communication network 108 may include one or more wired and/or wireless networks. For example, communication network 108 may include a cellular network (e.g., a long-term evolution (LTE) network, a third generation (3G) network, a fourth generation (4G) network, a fifth generation (5G) network, a code division multiple access (CDMA) network, etc.), a public land mobile network (PLMN), a local area network (LAN), a wide area network (WAN), a metropolitan area network (MAN), a telephone network (e.g., the public switched telephone network (PSTN) and/or the like), a private network, an ad hoc network, an intranet, the Internet, a fiber optic-based network, a cloud computing network, and/or the like, and/or a combination of some or all of these or other types of networks.

The number and arrangement of devices and networks shown in FIG. 1 are provided as an example. There may be additional devices and/or networks, fewer devices and/or networks, different devices and/or networks, or differently arranged devices and/or networks than those shown in FIG. 1. Furthermore, two or more devices shown in FIG. 1 may be implemented within a single device, or a single device shown in FIG. 1 may be implemented as multiple, distributed devices. Additionally or alternatively, a set of devices (e.g., one or more devices) of environment 100 may perform one or more functions described as being performed by another set of devices of environment 100.

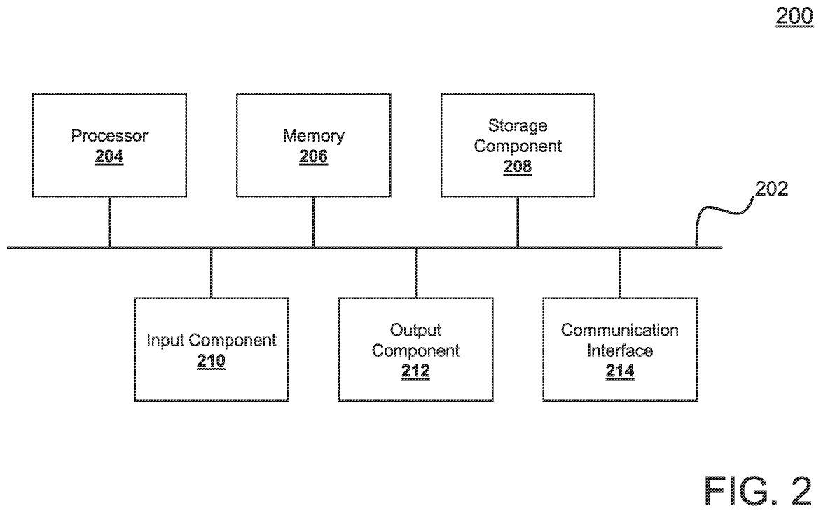

Referring now to FIG. 2, FIG. 2 is a diagram of example components of a device 200. Device 200 may correspond to anomaly detection system 102 (e.g., one or more devices of anomaly detection system 102), transaction service provider system 104 (e.g., one or more devices of transaction service provider system 104), and/or user device 106. In some non-limiting embodiments or aspects, anomaly detection system 102, transaction service provider system 104, and/or user device 106 may include at least one device 200 and/or at least one component of device 200. As shown in FIG. 2, device 200 may include bus 202, processor 204, memory 206, storage component 208, input component 210, output component 212, and communication interface 214.

Bus 202 may include a component that permits communication among the components of device 200. In some non-limiting embodiments, processor 204 may be implemented in hardware, software, or a combination of hardware and software. For example, processor 204 may include a processor (e.g., a central processing unit (CPU), a graphics processing unit (GPU), an accelerated processing unit (APU), etc.), a microprocessor, a digital signal processor (DSP), and/or any processing component (e.g., a field-programmable gate array (FPGA), an application-specific integrated circuit (ASIC), etc.) that can be programmed to perform a function. Memory 206 may include random access memory (RAM), read-only memory (ROM), and/or another type of dynamic or static storage memory (e.g., flash memory, magnetic memory, optical memory, etc.) that stores information and/or instructions for use by processor 204.

Storage component 208 may store information and/or software related to the operation and use of device 200. For example, storage component 208 may include a hard disk (e.g., a magnetic disk, an optical disk, a magneto-optic disk, a solid state disk, etc.), a compact disc (CD), a digital versatile disc (DVD), a floppy disk, a cartridge, a magnetic tape, and/or another type of computer-readable medium, along with a corresponding drive.

Input component 210 may include a component that permits device 200 to receive information, such as via user input (e.g., a touch screen display, a keyboard, a keypad, a mouse, a button, a switch, a microphone, etc.). Additionally or alternatively, input component 210 may include a sensor for sensing information (e.g., a global positioning system (GPS) component, an accelerometer, a gyroscope, an actuator, etc.). Output component 212 may include a component that provides output information from device 200 (e.g., a display, a speaker, one or more light-emitting diodes (LEDs), etc.).

Communication interface 214 may include a transceiver-like component (e.g., a transceiver, a separate receiver and transmitter, etc.) that enables device 200 to communicate with other devices, such as via a wired connection, a wireless connection, or a combination of wired and wireless connections. Communication interface 214 may permit device 200 to receive information from another device and/or provide information to another device. For example, communication interface 214 may include an Ethernet interface, an optical interface, a coaxial interface, an infrared interface, a radio frequency (RF) interface, a universal serial bus (USB) interface, a Wi-Fi® interface, a cellular network interface, and/or the like.

Device 200 may perform one or more processes described herein. Device 200 may perform these processes based on processor 204 executing software instructions stored by a computer-readable medium, such as memory 206 and/or storage component 208. A computer-readable medium (e.g., a non-transitory computer-readable medium) is defined herein as a non-transitory memory device. A memory device includes memory space located inside of a single physical storage device or memory space spread across multiple physical storage devices.

Software instructions may be read into memory 206 and/or storage component 208 from another computer-readable medium or from another device via communication interface 214. When executed, software instructions stored in memory 206 and/or storage component 208 may cause processor 204 to perform one or more processes described herein. Additionally or alternatively, hardwired circuitry may be used in place of or in combination with software instructions to perform one or more processes described herein. Thus, embodiments described herein are not limited to any specific combination of hardware circuitry and software.

The number and arrangement of components shown in FIG. 2 are provided as an example. In some non-limiting embodiments, device 200 may include additional components, fewer components, different components, or differently arranged components than those shown in FIG. 2. Additionally or alternatively, a set of components (e.g., one or more components) of device 200 may perform one or more functions described as being performed by another set of components of device 200.

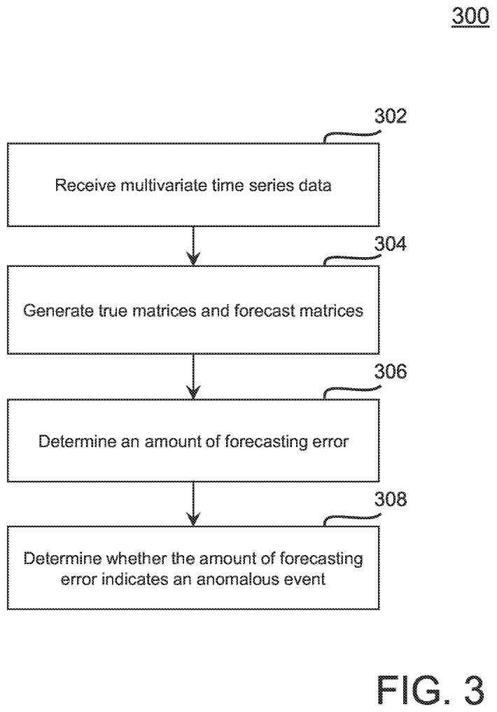

Referring now to FIG. 3, FIG. 3 is a flowchart of a non-limiting embodiment or aspect of a process 300 for detecting an anomaly in a multivariate time series. In some non-limiting embodiments or aspects, one or more of the steps of process 300 may be performed (e.g., completely, partially, etc.) by anomaly detection system 102 (e.g., one or more devices of anomaly detection system 102). In some non-limiting embodiments or aspects, one or more of the steps of process 300 may be performed (e.g., completely, partially, etc.) by another device or a group of devices separate from or including anomaly detection system 102 (e.g., one or more devices of anomaly detection system 102), transaction service provider system 104 (e.g., one or more devices of transaction service provider system 104), and/or user device 106.

As shown in FIG. 3, at step 302, process 300 includes receiving a multivariate time series data. For example, anomaly detection system 102 may receive the multivariate time series data. In some non-limiting embodiments or aspects, anomaly detection system 102 may receive a dataset that includes a plurality of data instances. Each data instance may include a time series, such as a multivariate time series, of data points.

In some non-limiting embodiments, anomaly detection system 102 may determine a set of target data instances based on the dataset. In some non-limiting embodiments or aspects, each target data instance of the set of target data instances is associated with a first time period. In some non-limiting embodiments or aspects, anomaly detection system 102 may determine a set of historical data instances based on the dataset. In some non-limiting embodiments or aspects, each historical data instance of the set of historical data instances is associated with a second time period and the second time period may be prior to the first time period.

As shown in FIG. 3, at step 304, process 300 includes generating true matrices and forecast matrices. For example, anomaly detection system 102 may generate the true matrices and the forecast matrices. In some non-limiting embodiments or aspects, anomaly detection system 102 may generate, based on the set of target data instances, a true value matrix, a true frequency matrix, and/or a true correlation matrix. In some non-limiting embodiments or aspects, anomaly detection system 102 may generate the true value matrix based on a number of time series of data points in the set of target data instances and a number of time steps in a target window segment of data points. In some non-limiting embodiments or aspects, anomaly detection system 102 may generate the true frequency matrix based on a discrete Fourier transform of the true value matrix. In some non-limiting embodiments or aspects, anomaly detection system 102 may generate the true correlation matrix based on cosine similarity scores between a plurality of time series of data points of the plurality of data instances.

In some non-limiting embodiments or aspects, anomaly detection system 102 may generate a forecast value matrix based on the set of target data instances and the set of historical data instances. Additionally or alternatively, anomaly detection system 102 may generate a forecast frequency matrix based on the set of target data instances and the set of historical data instances. Additionally or alternatively, anomaly detection system 102 may generate a forecast correlation matrix based on the set of target data instances and the set of historical data instances.

In some non-limiting embodiments or aspects, anomaly detection system 102 may generate a historical true value matrix based on a number of time series of data points in the set of target data instances and a number of time steps in a target window segment of data points.

In some non-limiting embodiments or aspects, anomaly detection system 102 may provide the historical true value matrix as an input to a dilated convolutional neural network (CNN) to generate an output of the dilated CNN and generate the forecast value matrix based on the output of the dilated CNN.

In some non-limiting embodiments or aspects, anomaly detection system 102 may generate a sequence of window segments based on the historical true value matrix, generate a plurality of correlation matrices based on cosine similarity scores of the sequence of window segments, provide the plurality of correlation matrices as an input to a convolutional long short-term memory (ConvLSTM) neural network to generate an output of the ConvLSTM neural network, provide the output of the ConvLSTM neural network as an input to an attention mechanism to generate an output of the attention mechanism, and generate the forecast frequency matrix based on the output of the attention mechanism.

As shown in FIG. 3, at step 306, process 300 includes determining an amount of forecasting error. For example, anomaly detection system 102 may determine the amount of forecasting error. In some non-limiting embodiments or aspects, anomaly detection system 102 may determine the amount of forecasting error between the forecast value matrix, the forecast frequency matrix, and the forecast correlation matrix, and the true value matrix, the true frequency matrix, and the true correlation matrix.

In some non-limiting embodiments or aspects, anomaly detection system 102 may concatenate the true value matrix, the true frequency matrix, and the true correlation matrix to generate a forecasting input matrix, concatenate the forecast value matrix, the forecast frequency matrix, and the forecast correlation matrix to generate a forecasting output matrix, and determine the amount of forecasting error based on the forecasting input matrix and the forecasting output matrix.

In some non-limiting embodiments or aspects, anomaly detection system 102 may determine a measure of loss associated with a forecasting error mean for batches of input data instances of the dataset of data instances based on the forecasting input matrix and the forecasting output matrix, determine a measure of loss associated with a variance of forecasting error for each batch of input data instances of the dataset of data instances based on the forecasting input matrix and the forecasting output matrix, and determine the amount of forecasting error based on the measure of loss associated with a forecasting error mean for batches of data instances and the measure of loss associated with the variance of forecasting error for each batch of data instances.

As shown in FIG. 3, at step 308, process 300 includes determining whether the amount of forecasting error indicates an anomalous event. For example, anomaly detection system 102 may determine whether the amount of forecasting error indicates an anomalous event. In some non-limiting embodiments or aspects, anomaly detection system 102 may determine whether the amount of forecasting error corresponds to an anomalous event associated with the dataset of data instances. In some non-limiting embodiments or aspects, an anomalous event may include input data (e.g., the amount of forecasting error) that deviates (e.g., differs from a threshold value) from a range of prediction values (e.g., a prediction range) of one or more machine learning models.

In some non-limiting embodiments or aspects, anomaly detection system 102 may determine whether the amount of forecasting error satisfies a threshold value of forecasting error and determine whether the dataset of data instances includes an anomalous event based on determining whether the amount of forecasting error satisfies the threshold value of forecasting error.

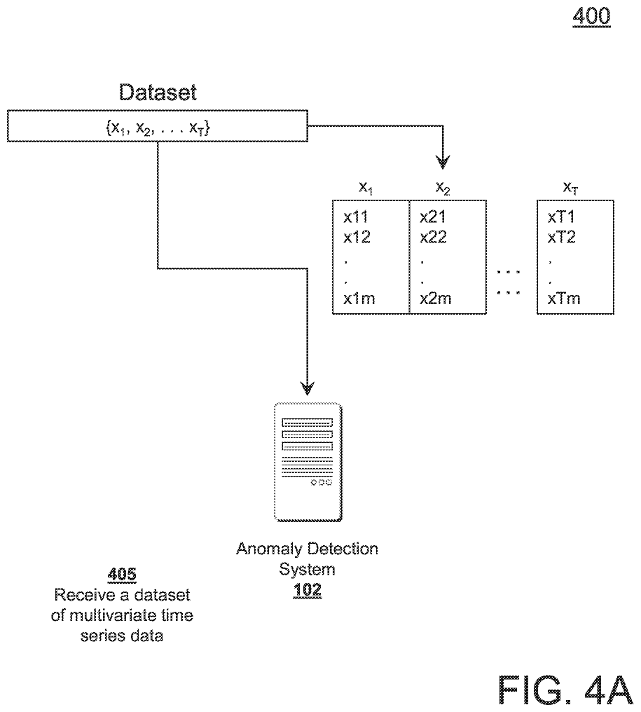

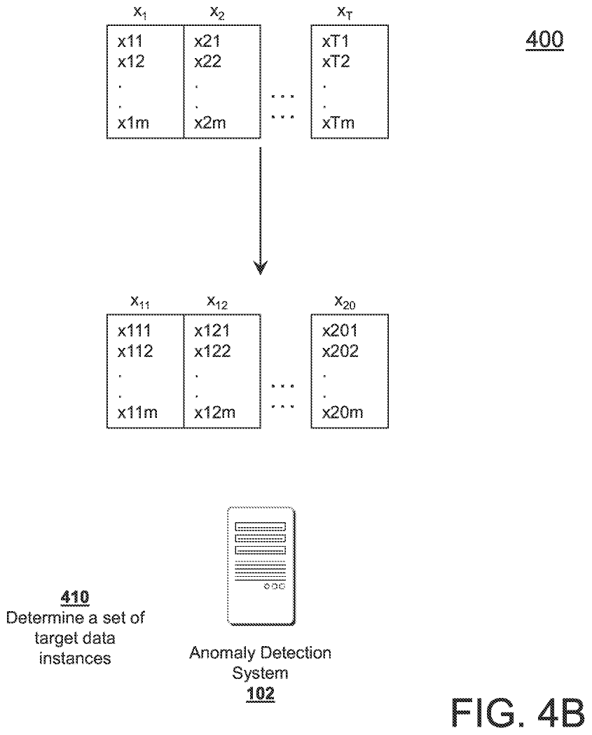

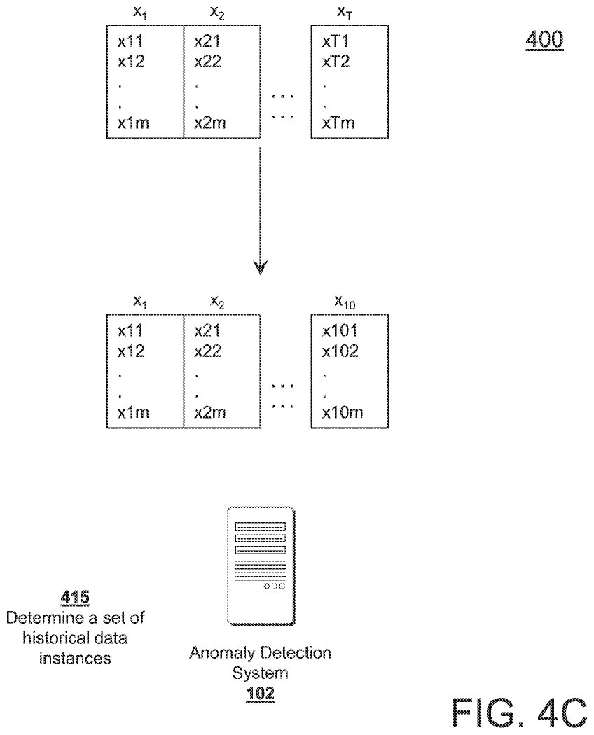

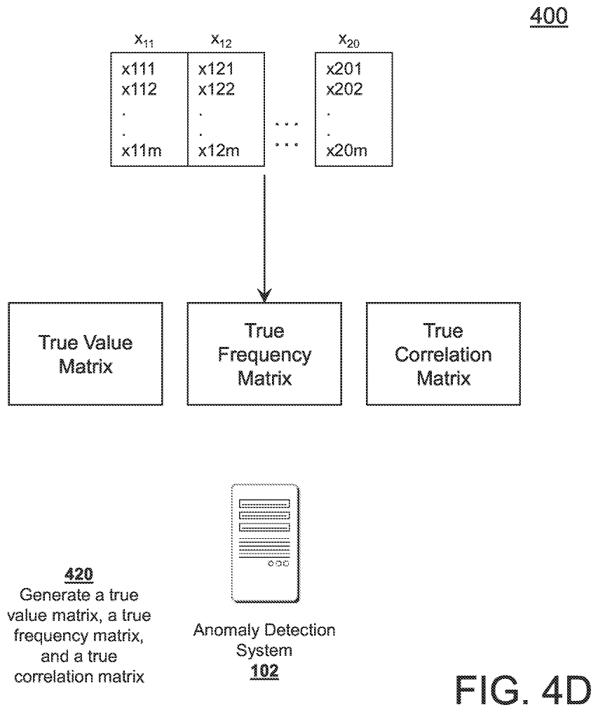

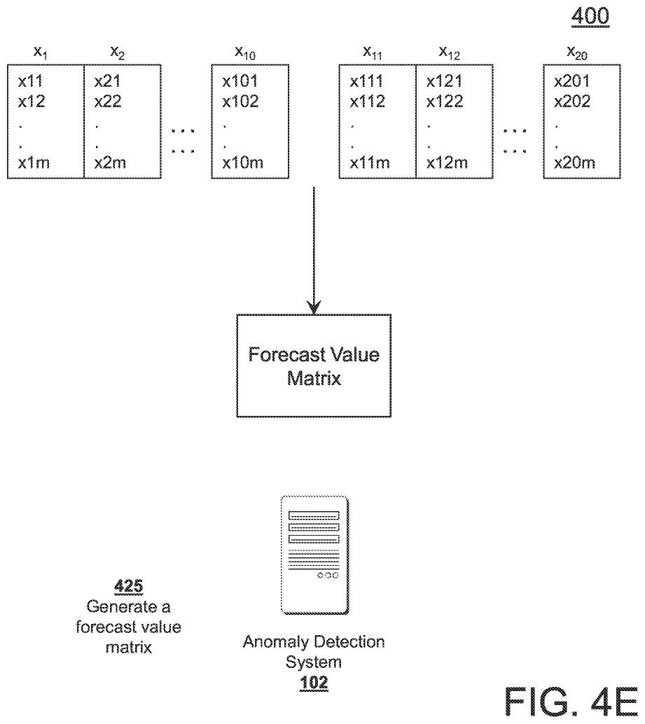

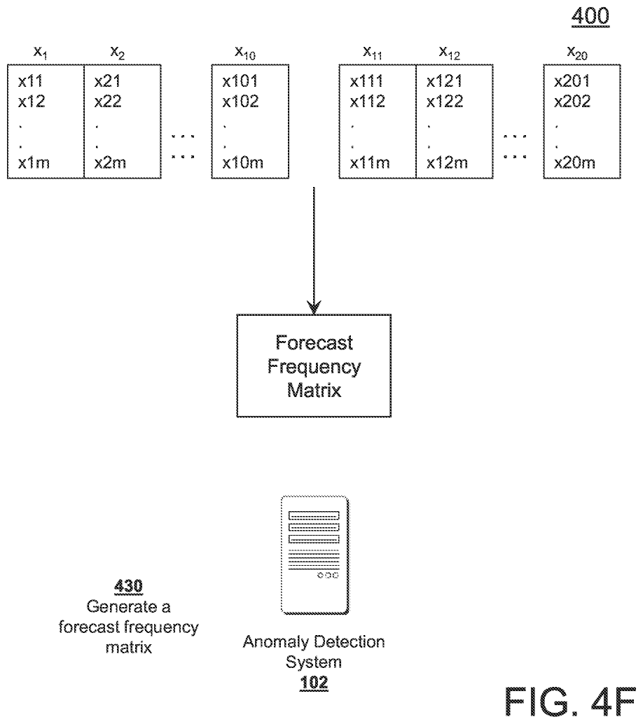

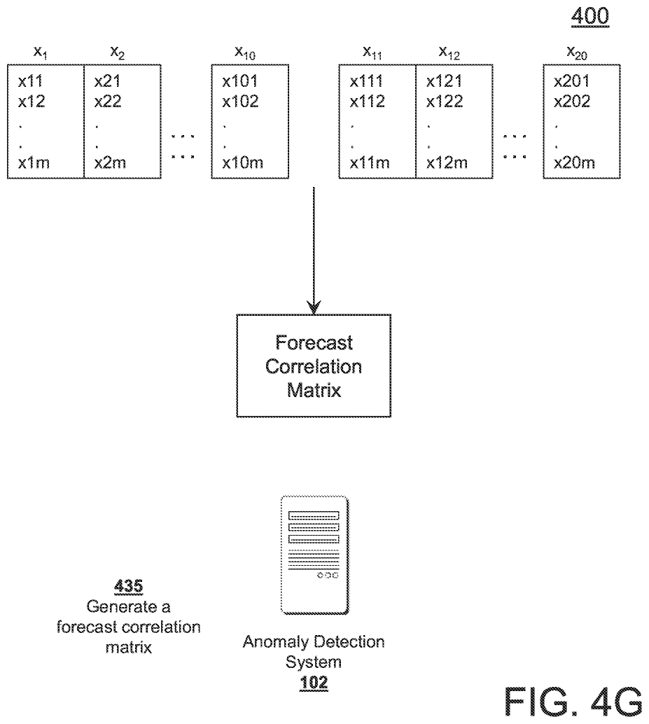

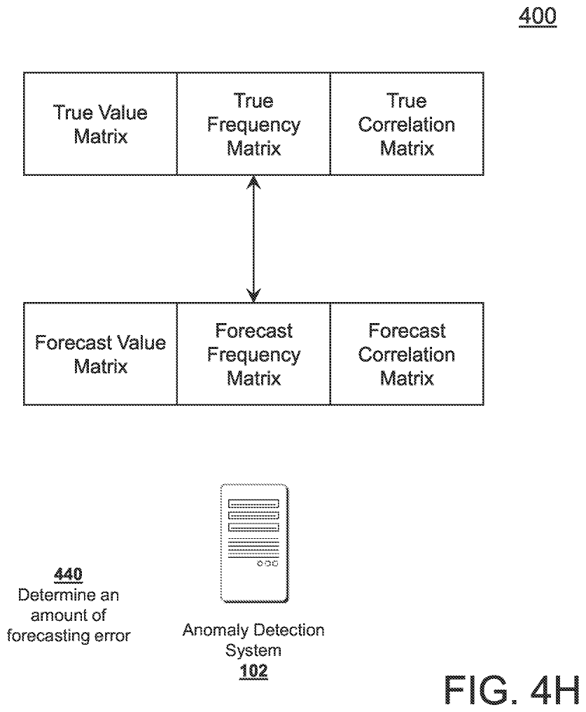

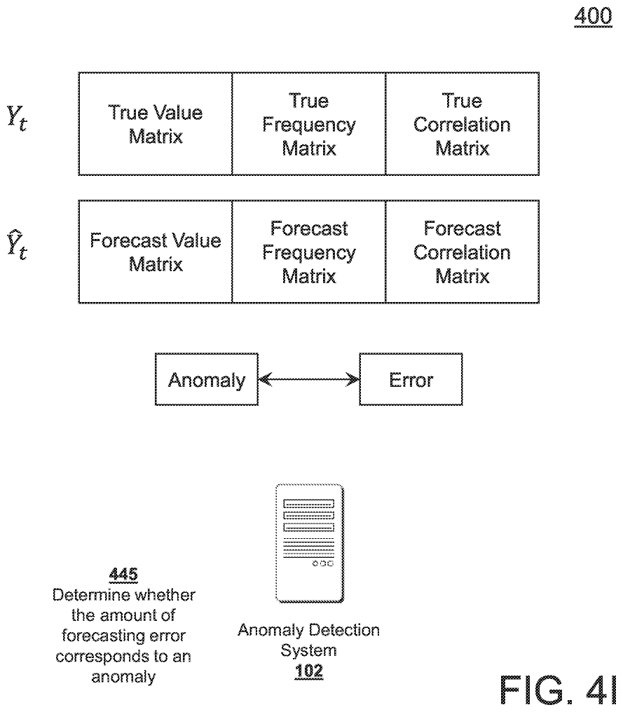

Referring now to FIGS. 4A-4I, FIGS. 4A-4I are diagrams of non-limiting embodiments or aspects of an implementation 400 of a process (e.g., process 300) for detecting an anomaly in a multivariate time series.

As shown by reference number 405 in FIG. 4A, anomaly detection system 102 may receive a dataset of multivariate time series data. For example, anomaly detection system 102 may receive the dataset of a plurality of data instances including multivariate time series data. In some non-limiting embodiments or aspects, each data instance may include a time series of data points (e.g., multivariate time series data). In some non-limiting embodiments or aspects, anomaly detection system 102 may receive the dataset of the plurality of data instances including multivariate time series data as input to one or more machine learning models for training (e.g., for training one or more machine learning models). In some non-limiting embodiments or aspects, anomaly detection system 102 may receive the dataset of the plurality of data instances including multivariate time series data as input to one or more machine learning models for generating a prediction (e.g., generating a prediction, inference, label, and/or the like during runtime).

In some non-limiting embodiments or aspects, the dataset of the plurality of data instances may include a number of data instances corresponding to a number of time steps in the dataset. For example, as shown in FIG. 4A, T may include a value that is equal to a total number of time steps in the dataset (e.g., a first time period). In some non-limiting embodiments or aspects, each data instance may correspond to a time step. In some non-limiting embodiments or aspects, each data instance may include a number of features. For example, as shown in FIG. 4A, m may include a value that is equal to a total number of features in each data instance of the dataset.

In some non-limiting embodiments or aspects, a dataset [symbol] may be represented by the following equation:

[symbol]

={x₁,x₂, . . . ,x_{T}}

where xᵢ∈ [symbol] ^{m} for i∈{1, . . . , T}, and T is a value that is equal to a total number of time steps in the dataset.

As shown by reference number 410 in FIG. 4B, anomaly detection system 102 may determine a set of target data instances. For example, anomaly detection system 102 may determine the set of target data instances based on the dataset of the plurality of data instances. In some non-limiting embodiments or aspects, each target data instance of the set of target data instances may be associated with (e.g., part of) a first time period. For example, as shown in FIG. 4B, anomaly detection system 102 may determine the set of target data instances based on the dataset of the plurality of data instances associated with a first time period including time steps 11 through 20 (e.g., x₁₁ through x₂₀).

In some non-limiting embodiments or aspects, each data instance of the plurality of data instances may include one or more features (e.g., where m is a value equal to a total number of features). For example, as shown in FIG. 4B, anomaly detection system 102 may determine a set of target data instances based on the dataset of the plurality of data instances associated with a first time period including time steps 11 through 20, where each data instance (e.g., each data instance corresponding to a time step) includes a number of features. As shown in FIG. 4B, data instance x₁₁ may include features x₁₁₁ through x₁₁ₘ, where m is a value equal to a total number of features.

As shown by reference number 415 in FIG. 4C, anomaly detection system 102 may determine a set of historical data instances. For example, anomaly detection system 102 may determine the set of historical data instances based on the dataset of the plurality of data instances. In some non-limiting embodiments or aspects, each historical data instance of the set of historical data instances may be associated with (e.g., part of) a second time period. For example, as shown in FIG. 4C, anomaly detection system 102 may determine the set of historical data instances based on the dataset of the plurality of data instances associated with a second time period including time steps 1 through 10 (e.g., x₁ through x₁₀). In some non-limiting embodiments or aspects, the second time period may be prior to (e.g., earlier than, previous in time) the first time period.

In some non-limiting embodiments or aspects, each data instance of the plurality of data instances may include one or more features (e.g., where m is a value equal to a total number of features). For example, as shown in FIG. 4C, anomaly detection system 102 may determine a set of historical data instances based on the dataset of the plurality of data instances associated with a second time period including time steps 1 through 10, where each data instance (e.g., each data instance corresponding to a time step) includes a number of features. As shown in FIG. 4C, data instance x₁ may include features x₁₁ through x₁ₘ, where m is a value equal to a total number of features.

As shown by reference number 420 in FIG. 4D, anomaly detection system 102 may generate a true value matrix, a true frequency matrix, and a true correlation matrix. For example, anomaly detection system 102 may generate the true value matrix, the true frequency matrix, and the true correlation matrix based on the set of target data instances. In some non-limiting embodiments or aspects, anomaly detection system 102 may generate the true value matrix based on one or more target window segments of data points. In some non-limiting embodiments or aspects, the true value matrix may include one or more target window segments of data points.

In some non-limiting embodiments or aspects, when generating the true value matrix, anomaly detection system 102 may generate the true value matrix based on a number of time series of data points in the set of target data instances and a number of time steps in a target window segment of data points. Additionally or alternatively, when generating the true frequency matrix, anomaly detection system 102 may generate the true frequency matrix based on a discrete Fourier transform of the true value matrix. Additionally or alternatively, when generating the true correlation matrix, anomaly detection system 102 may generate the true correlation matrix based on cosine similarity scores between a plurality of time series of data points of the plurality of data instances. In this way, cosine similarity may reduce the occurrence of scaling effects and may achieve enhanced correlation effects.

In some non-limiting embodiments or aspects, the discrete Fourier transform may be based on the following equation:

$${ξ}_{j} = \frac{1}{k} {\sum }_{ℓ = 0}^{k - 1} {x}_{l} {e}^{2 π ij ℓ / k} , j = 1 , 2 , … , k$$

where i is an imaginary unit. In this way, anomaly detection system 102 may generate the true frequency matrix based on the discrete Fourier transform of the target window segments of data points.

In some non-limiting embodiments or aspects, the true correlation matrix may include a matrix Sₜ that is an m x m matrix where an entry at a row and a column may be based on a cosine similarity score between the time series (e.g., the data instance) corresponding to the row and the time series corresponding to the column. For example, anomaly detection system 102 may generate the true correlation matrix based on a cosine similarity score between time series (e.g., data instance) x₁ and time series x₁₁, where the entry at the first row and the eleventh column of the true correlation matrix is based on the cosine similarity score between time series x₁ and time series x₁₁.

In some non-limiting embodiments or aspects, anomaly detection system 102 may generate a historical value matrix. For example, anomaly detection system 102 may generate a historical true value matrix based on a number of time series of data points in the set of target data instances. Additionally or alternatively, anomaly detection system 102 may generate the historical true value matrix based on a number of time steps in a target window segment of data points. In some non-limiting embodiments or aspects, the number of time steps in a target window segment of data points may be less than the total number of time steps in the dataset (e.g., the value of T that is equal to the total number of time steps in the dataset). In some non-limiting embodiments or aspects, a target window segment of data points W t may be represented by the following equation:

Wₜ={xₜ₋ₖ₊₁,xₜ₋ₖ₊₂, . . . ,xₜ}

where Wₜ∈ [symbol] ^{m×k} is a target window segment of data points with a length k at a time t. In some non-limiting embodiments or aspects, the length k may include a value equal to a number of time steps in the target window segment of data points.

In some non-limiting embodiments or aspects, the dataset [symbol] may be transformed into a sequence of windows W defined by the following equation:

W={Wₖ, . . . ,W_{T}}.

In some non-limiting embodiments or aspects, for each target window segment of data points Wₜ, anomaly detection system 102 may train one or more machine learning models based on the sequence of windows W.

In some non-limiting embodiments or aspects, anomaly detection system 102 may concatenate a historical window segment of data points Wₜ^{h} and the target window segment of data points Wₜ to produce an input. In some non-limiting embodiments or aspects, the input may be represented by the following equation:

Iₜ=[Wₜ^{h};Wₜ]

which may take the form of a m×τ matrix given by the following equation:

Iₜ={x_{t-τ+1},x_{t-τ+2}, . . . ,xₜ}

where m is a value equal to a number of features and τ is a value equal to a number of time steps included in the historical data instances based on the dataset (e.g., the second time period).

As shown by reference number 425 in FIG. 4E, anomaly detection system 102 may generate a forecast value matrix. For example, anomaly detection system 102 may generate a forecast value matrix based on the set of target data instances and the set of historical data instances. In some non-limiting embodiments or aspects, when generating the forecast value matrix, anomaly detection system 102 may provide the historical true value matrix as an input to a dilated convolutional neural network (CNN). In some non-limiting embodiments or aspects, anomaly detection system 102 may provide the historical true value matrix as an input to the dilated CNN to generate an output of the dilated CNN. In some non-limiting embodiments or aspects, when generating the forecast value matrix, anomaly detection system 102 may generate the forecast value matrix based on the output of the dilated CNN.

In some non-limiting embodiments or aspects, anomaly detection system 102 may generate an output of the dilated CNN based on the following equation:

$$( F {*}_{ℓ} k ) ( p ) = {\sum }_{s + ℓ t = p} F ( s ) k ( t )$$

where F is a discrete function, k is a convolution kernel, [symbol] is a dilation factor, and [symbol] is a dilated convolution operator. In this way, anomaly detection system 102 may apply different dilation factors to obtain multi-scale information without losing resolution. For example, anomaly detection system 102 may apply a 3-layer dilated CNN with dilation factors 1, 3, and 5 and respective channel numbers 32, 64, and 128 to obtain a deep hidden representation. Anomaly detection system 102 may apply a rectangular kernel (3, 1) for each layer to limit multi-scale aggregation over the time dimension rather than the feature dimension. Anomaly detection system 102 may decode the hidden representation to forecast the target window segments of data points.

As shown by reference number 430 in FIG. 4F, anomaly detection system 102 may generate a forecast frequency matrix. For example, anomaly detection system 102 may generate a forecast frequency matrix based on the set of target data instances and the set of historical data instances. In some non-limiting embodiments or aspects, when generating the forecast frequency matrix, anomaly detection system 102 may generate a sequence of window segments based on the historical true value matrix. In some non-limiting embodiments or aspects, when generating the forecast frequency matrix, anomaly detection system 102 may generate a plurality of correlation matrices based on cosine similarity scores of the sequence of window segments.

In some non-limiting embodiments or aspects, when generating the forecast frequency matrix, anomaly detection system 102 may provide the plurality of correlation matrices as an input to a convolutional long short-term memory (ConvLSTM) neural network. In some non-limiting embodiments or aspects, anomaly detection system 102 may provide the plurality of correlation matrices as an input to the ConvLSTM neural network to generate an output of the ConvLSTM neural network. In some non-limiting embodiments or aspects, anomaly detection system 102 may provide the output of the ConvLSTM neural network as an input to an attention mechanism to generate an output of the attention mechanism.

As shown by reference number 435 in FIG. 4G, anomaly detection system 102 may generate a forecast correlation matrix. For example, anomaly detection system 102 may generate a forecast correlation matrix based on the set of target data instances and the set of historical data instances. In some non-limiting embodiments or aspects, when generating the forecast correlation matrix, anomaly detection system 102 may generate a sequence of window segments based on the historical true value matrix. In some non-limiting embodiments or aspects, when generating the forecast correlation matrix, anomaly detection system 102 may generate a plurality of frequency matrices based on a discrete Fourier transform of the sequence of window segments. In some non-limiting embodiments or aspects, the discrete Fourier transform may be based on the following equation:

$${ξ}_{j} = \frac{1}{k} {\sum }_{ℓ = 0}^{k - 1} {x}_{l} {e}^{2 π ij ℓ / k} , j = 1 , 2 , … , k$$

where i is an imaginary unit. In this way, anomaly detection system 102 may generate a plurality of frequency matrices \vec{ξ}={ξ₁, ξ₂, . . . , ξₖ} based on the discrete Fourier transform of the sequence of window segments.

In some non-limiting embodiments or aspects, when generating the forecast correlation matrix, anomaly detection system 102 may provide the plurality of frequency matrices as an input to a ConvLSTM neural network. In some non-limiting embodiments or aspects, anomaly detection system 102 may provide the plurality of frequency matrices as an input to the ConvLSTM neural network to generate an output of the ConvLSTM neural network. In some non-limiting embodiments or aspects, anomaly detection system 102 may provide the output of the ConvLSTM neural network as an input to an attention mechanism to generate an output of the attention mechanism. In some non-limiting embodiments or aspects, when generating the forecast correlation matrix, anomaly detection system 102 may generate the forecast correlation matrix based on the output of the attention mechanism.

In some non-limiting embodiments or aspects, the ConvLSTM neural network may be formulated based on the following equations:

iₜ=σ(Wₛᵢ*Sₜ+Wₕᵢ*Hₜ₋₁+W_{ci}∘Cₜ₋₁+bᵢ)

fₜ=σ(W_{sf}*Sₜ+W_{hf}*Hₜ₋₁+W_{cf}∘Cₜ₋₁+b_{f})

Cₜ=fₜ∘Cₜ₋₁+iₜ∘ tanh(W_{sc}*Sₜ+W_{hc}*Hₜ₋₁+b_{c})

oₜ=σ(Wₛₒ*Sₜ+Wₕₒ*Hₜ₋₁+W_{co}∘Cₜ+bₒ)

Hₜ=oₜ∘ tanh(Cₜ)

where iₜ is an input gate, fₜ is a forget gate, oₜ is an output gate, Cₜ is a cell state, Hₜ is a hidden state, W is a window segment of data points, Sₜ is the true correlation matrix, * is a convolution operator, ∘ is a Hadamard product, and σ(⋅) is a sigmoid function.

In some non-limiting embodiments or aspects, anomaly detection system 102 may apply an attention mechanism when generating the output of the attention mechanism. Anomaly detection system 102 may apply the attention mechanism based on the following equation:

$${H}_{t}^{*} = {\sum }_{i = t - k}^{t} {c}_{i} {H}_{i} , {c}_{i} = \frac{exp 〈 vet ( {H}_{i} ) , vet ( {H}_{t} ) 〉}{{\sum }_{j = t - k}^{t} exp 〈 vet ( {H}_{j} ) , vet ( {H}_{t} ) 〉}$$

where vec(⋅) is a matrix flattened into a vector, [symbol] ⋅,⋅ [symbol] is an inner product, H*ₜ is a representation for a window t. In some non-limiting embodiments or aspects, anomaly detection system 102 may project the representation for the window t into a lower dimensional space and anomaly detection system 102 may apply a fully-connected layer to generate a forecast correlation matrix.

As shown by reference 440 in FIG. 4H, anomaly detection system 102 may determine an amount of forecasting error. For example, anomaly detection system 102 may determine the amount of forecasting error between the forecast value matrix, the forecast frequency matrix, and the forecast correlation matrix. In some non-limiting embodiments or aspects, anomaly detection system 102 may determine the amount of forecasting error between the true value matrix, the true frequency matrix, and the true correlation matrix.

In some non-limiting embodiments or aspects, when determining the amount of forecasting error, anomaly detection system 102 may concatenate the true value matrix, the true frequency matrix, and the true correlation matrix to generate a forecasting input matrix. In some non-limiting embodiments or aspects, when determining the amount of forecasting error, anomaly detection system 102 may concatenate the forecast value matrix, the forecast frequency matrix, and the forecast correlation matrix to generate a forecasting output matrix. In some non-limiting embodiments or aspects, when determining the amount of forecasting error, anomaly detection system 102 may determine the amount of forecasting error based on the forecasting input matrix and the forecasting output matrix.

In some non-limiting embodiments or aspects, when determining the amount of forecasting error, anomaly detection system 102 may determine a measure of loss associated with a forecasting error mean for batches of input data instances of the dataset of the plurality of data instances. In some non-limiting embodiments or aspects, anomaly detection system 102 may determine the measure of loss associated with a forecasting error mean based on the forecasting input matrix and the forecasting output matrix.

In some non-limiting embodiments or aspects, anomaly detection system 102 may determine a measure of loss associated with a forecasting error mean for batches of input data instances of the dataset of the plurality of data instances based on the following equation:

$${ℓ}_{1} = \frac{1}{b} {\sum }_{i = 1}^{b} {‖ {Y}_{i} - {\hat{Y}}_{t} ‖}_{2}^{2}$$

where b is a batch size, Yᵢ=[Sᵢ; Fᵢ; Wᵢ] is a concatenation of the true correlation matrix, the true frequency matrix, and the true value matrix at a time step i, and Ŷᵢ=[Ŝᵢ; \hat{F}ᵢ; Ŵᵢ] is a concatenation of the forecast correlation matrix, the forecast frequency matrix, and the forecast value matrix at a time step i.

In some non-limiting embodiments or aspects, when determining the amount of forecasting error, anomaly detection system 102 may determine a measure of loss associated with a variance of forecasting error for each batch of input data instances of the dataset of the plurality of data instances. In some non-limiting embodiments or aspects, anomaly detection system 102 may determine the measure of loss associated with a variance of forecasting error based on the forecasting input matrix and the forecasting output matrix.

In some non-limiting embodiments or aspects, anomaly detection system 102 may determine a measure of loss associated with a variance of forecasting error for each batch of input data instances of the dataset of the plurality of data instances based on the following equation:

$${ℓ}_{2} = \frac{1}{n b} {\sum }_{i = 1}^{b} {z}_{i}^{T} {z}_{i} , {z}_{i} = {\hat{Y}}_{i} - \frac{1}{b - 1} {\sum }_{j \neq i} \hat{{Y}_{j}}$$

where

$$n = m + k + \frac{k}{2}$$

is a number of columns of Ŷᵢ, is a batch size, T is a total number of time steps, i is a time step (e.g., row of a matrix), and j is an index of a feature (e.g., column of a matrix). In this way, anomaly detection system 102 may generate a measure of loss associated with a variance of forecasting error [symbol] ₂ which may allow anomaly detection system 102 to obtain a compact representation that is more sensitive to anomalies, thus improving the capability of anomaly detection system 102 to detect anomalies.

In some non-limiting embodiments or aspects, when determining the amount of forecasting error, anomaly detection system 102 may determine the amount of forecasting error based on the measure of loss associated with a forecasting error mean for batches of data instances. Additionally or alternatively, anomaly detection system 102 may determine the amount of forecasting error based on the measure of loss associated with the variance of forecasting error for each batch of data instances. For example, anomaly detection system 102 may determine the amount of forecasting error based on the measure of loss associated with a forecasting error mean for batches of data instances and the measure of loss associated with the variance of forecasting error for each batch of data instances.

In some non-limiting embodiments or aspects, anomaly detection system 102 may determine the amount of forecasting error based on the following equation:

[symbol]

=f( [symbol] ₁, [symbol] ₂)=(ϵ+ [symbol] ₂)· [symbol] ₁

where ϵ is a small positive constant (e.g., ϵ=10⁻⁵), [symbol] ₁ is the measure of loss associated with a forecasting error mean for batches of input data instances of the dataset of the plurality of data instances, and [symbol] ₂ is the measure of loss associated with a variance of forecasting error for each batch of input data instances of the dataset of the plurality of data instances. In this way, anomaly detection system 102 may determine the amount of forecasting error without needing to fine-tune weights, thus improving the efficiency of the training process. In addition, anomaly detection system 102 may determine the amount of forecasting error while scaling the loss values with the order of change of the measure of loss associated with a forecasting error mean and the measure of loss associated with a variance of forecasting error, thus allowing anomaly detection system 102 to emphasize each measure of loss to the same level regardless of the scale of each measure of loss. In this way, anomaly detection system 102 may improve the performance and accuracy of detecting an anomaly.

As shown by reference 445 in FIG. 4I, anomaly detection system 102 may determine whether the amount of forecasting error corresponds to an anomaly (e.g., anomalous event). For example, anomaly detection system 102 may determine whether the amount of forecasting error corresponds to an anomalous event associated with the dataset of the plurality of data instances. In some non-limiting embodiments or aspects, when determining whether the amount of forecasting error corresponds to an anomalous event associated with the dataset of the plurality of data instances, anomaly detection system 102 may determine whether the amount of forecasting error satisfies a threshold value of forecasting error. In some non-limiting embodiments or aspects, when determining whether the amount of forecasting error corresponds to an anomalous event associated with the dataset of the plurality of data instances, anomaly detection system 102 may determine whether the dataset of the plurality of data instances includes an anomalous event based on determining whether the amount of forecasting error satisfies the threshold value of forecasting error.

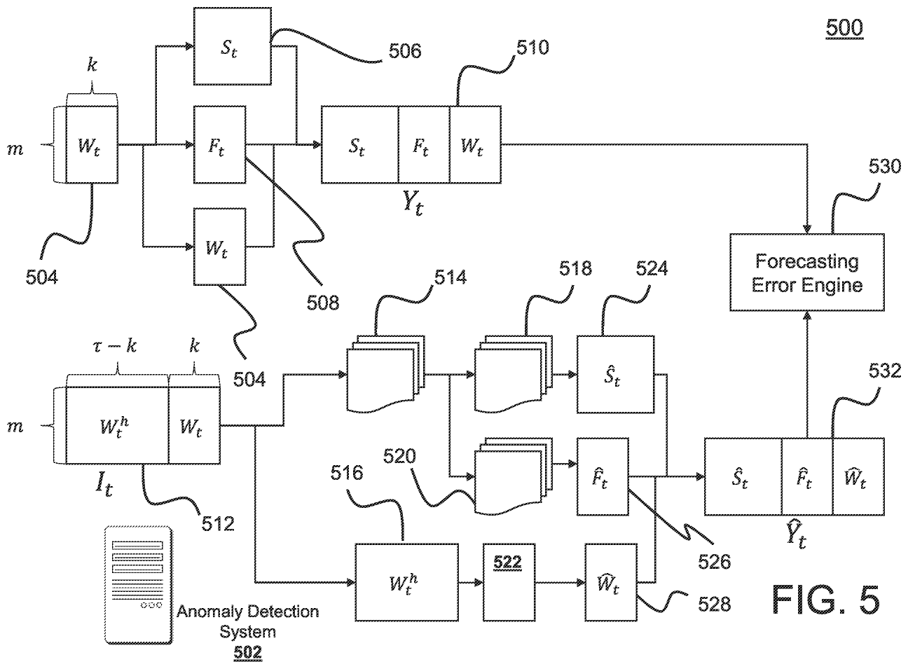

Referring now to FIG. 5, FIG. 5 is a diagram of a non-limiting embodiment of an implementation 500 in which systems, devices, products, apparatus, and/or methods, described herein, may be implemented according to the principles of the present disclosure.

As shown in FIG. 5, implementation 500 may include anomaly detection system 502, true value matrix 504 (e.g., Wₜ), true correlation matrix 506 (e.g., Sₜ), true frequency matrix 508 (e.g., Fₜ), forecasting input matrix 510 (e.g., Yₜ), true value input matrix 512 (e.g., Iₜ), sequence of window segments 514, historical true value matrix 516 (e.g., Wₜ^{h}), correlation matrices 518, frequency matrices 520, multi-scale hidden representation 522, forecast correlation matrix 524 (e.g., Ŝₜ), forecast frequency matrix 526 (e.g., \hat{F}ₜ), forecast value matrix 528 (e.g., Ŵₜ), forecasting error engine 530, and forecasting output matrix 532 (e.g., Ŷₜ). In some non-limiting embodiments or aspects, anomaly detection system 502 may be the same as or similar to anomaly detection system 102.

In some non-limiting embodiments or aspects, anomaly detection system 502 may include one or more of true value matrix 504, true correlation matrix 506, true frequency matrix 508, forecasting input matrix 510, true value input matrix 512, sequence of window segments 514, historical true value matrix 516, correlation matrices 518, frequency matrices 520, multi-scale hidden representation 522, forecast correlation matrix 524, forecast frequency matrix 526, forecast value matrix 528, forecasting error engine 530, and forecasting output matrix 532 as part of anomaly detection system 502.

In some non-limiting embodiments or aspects, one or more of true value matrix 504, true correlation matrix 506, true frequency matrix 508, forecasting input matrix 510, true value input matrix 512, sequence of window segments 514, historical true value matrix 516, correlation matrices 518, frequency matrices 520, multi-scale hidden representation 522, forecast correlation matrix 524, forecast frequency matrix 526, forecast value matrix 528, forecasting error engine 530, and forecasting output matrix 532 may be separate (e.g., part of another system) from anomaly detection system 502. In some non-limiting embodiments or aspects, anomaly detection system 502 may include one or more machine learning models (e.g., a CNN and/or the like).

In some non-limiting embodiments or aspects, anomaly detection system 502 may receive a dataset of multivariate time series data. For example, anomaly detection system 502 may receive the dataset of a plurality of data instances including multivariate time series data. In some non-limiting embodiments or aspects, each data instance may include a time series of data points (e.g., multivariate time series data). In some non-limiting embodiments or aspects, anomaly detection system 502 may receive the dataset of the plurality of data instances including multivariate time series data as input to one or more machine learning models for training (e.g., for training one or more machine learning models). In some non-limiting embodiments or aspects, anomaly detection system 502 may receive the dataset of the plurality of data instances including multivariate time series data as input to one or more machine learning models for generating a prediction (e.g., generating a prediction, inference, label, and/or the like during runtime). For example, anomaly detection system 502 may receive the dataset of the plurality of data instances including multivariate time series data as input to one or more machine learning models for generating a forecasting error (e.g., using forecasting error engine 530) and/or forecasting output matrix 532.

In some non-limiting embodiments or aspects, anomaly detection system 502 may determine a set of target data instances. For example, anomaly detection system 502 may determine the set of target data instances based on the dataset of the plurality of data instances. In some non-limiting embodiments or aspects, each target data instance of the set of target data instances may be associated with (e.g., part of) a first time period.

In some non-limiting embodiments or aspects, anomaly detection system 502 may determine a set of historical data instances. For example, anomaly detection system 502 may determine the set of historical data instances based on the dataset of the plurality of data instances. In some non-limiting embodiments or aspects, each historical data instance of the set of historical data instances may be associated with (e.g., part of) a second time period. In some non-limiting embodiments or aspects, the second time period may be prior to (e.g., earlier than, previous in time) the first time period.

In some non-limiting embodiments or aspects, anomaly detection system 502 may generate a true value matrix (e.g., true value matrix 504), a true frequency matrix (e.g., true frequency matrix 508), and a true correlation matrix (e.g., true correlation matrix 506). For example, anomaly detection system 502 may generate true value matrix 504, true frequency matrix 508, and true correlation matrix 506 based on the set of target data instances. In some non-limiting embodiments or aspects, anomaly detection system 502 may generate true value matrix 504 based on one or more target window segments of data points (e.g., one or more parts of true value matrix 504). In some non-limiting embodiments or aspects, true value matrix 504 may include one or more target window segments of data points.

In some non-limiting embodiments or aspects, when generating the true value matrix, anomaly detection system 502 may generate the true value matrix based on a number of time series of data points in the set of target data instances and a number of time steps in a target window segment of data points. Additionally or alternatively, when generating the true frequency matrix, anomaly detection system 502 may generate the true frequency matrix based on a discrete Fourier transform of the true value matrix. For example, anomaly detection system 502 may generate true frequency matrix 508 based on a discrete Fourier transform of true value matrix 504. Additionally or alternatively, when generating the true correlation matrix, anomaly detection system 502 may generate the true correlation matrix based on cosine similarity scores between a plurality of time series of data points of the plurality of data instances. In this way, cosine similarity may reduce the occurrence of scaling effects and may achieve enhanced correlation effects.

In some non-limiting embodiments or aspects, the discrete Fourier transform may be based on the following equation:

$${ξ}_{j} = \frac{1}{k} {\sum }_{ℓ = 0}^{k - 1} {x}_{l} {e}^{2 π ij ℓ / k} , j = 1 , 2 , … , k$$

where i is an imaginary unit. In this way, anomaly detection system 502 may generate true frequency matrix 508 based on the discrete Fourier transform of the target window segments of data points (e.g., true value matrix 504).

In some non-limiting embodiments or aspects, true correlation matrix 506 may include a matrix S t that is an m x m matrix where an entry at a row and a column may be based on a cosine similarity score between the time series (e.g., the data instance) corresponding to the row and the time series corresponding to the column. For example, anomaly detection system 502 may generate true correlation matrix 506 based on a cosine similarity score between time series (e.g., data instances) data points included in true value matrix 504 where the entry at a respective row and a respective column of true correlation matrix 506 is based on the cosine similarity score between time series data points included in true value matrix 504 at the respective row and the respective column of true value matrix 504.

In some non-limiting embodiments or aspects, anomaly detection system 502 may generate a historical value matrix. For example, anomaly detection system 502 may generate historical true value matrix 516 based on a number of time series of data points in the set of target data instances. Additionally or alternatively, anomaly detection system 502 may generate historical true value matrix 516 based on a number of time steps in a target window segment of data points (e.g., true value matrix 504). In some non-limiting embodiments or aspects, the number of time steps in a target window segment of data points may be less than the total number of time steps in the dataset (e.g., the value of T that is equal to the total number of time steps in the dataset). In some non-limiting embodiments or aspects, a target window segment of data points Wₜ (e.g., and/or true value matrix 504) may be represented by the following equation:

Wₜ={xₜ₋ₖ₊₁,xₜ₋ₖ₊₂, . . . ,xₜ}

where Wₜ∈ [symbol] ^{m×k} is a target window segment of data points with a length k at a time t. In some non-limiting embodiments or aspects, the length k may include a value equal to a number of time steps in the target window segment of data points.

In some non-limiting embodiments or aspects, the dataset [symbol] may be transformed into a sequence of windows W (e.g., sequence of window segments 514) defined by the following equation:

W={Wₖ, . . . ,W_{T}}.

In some non-limiting embodiments or aspects, for each target window segment of data points, anomaly detection system 502 may train one or more machine learning models based on the sequence of windows W (e.g., sequence of window segments 514).

In some non-limiting embodiments or aspects, anomaly detection system 502 may concatenate a historical window segment of data points Wₜ^{h} and the target window segment of data points Wₜ to produce an input (e.g., true value input matrix 512). In some non-limiting embodiments or aspects, the input may be represented by the following equation:

Iₜ=[Wₜ^{h};Wₜ]

which may take the form of a m×τ matrix given by the following equation:

Iₜ={x_{t-τ+1}, x_{t-τ+2}, . . . ,xₜ}

where m is a value equal to a number of features and τ is a value equal to a number of time steps included in the historical data instances based on the dataset (e.g., the second time period). For example, anomaly detection system 502 may concatenate a historical window segment of data points Wₜ^{h} (e.g., and/or historical true value matrix 516) and the target window segment of data points W t (e.g., and/or true value matrix 504) to produce true value input matrix 512.

In some non-limiting embodiments or aspects, anomaly detection system 502 may generate a forecast value matrix. For example, anomaly detection system 502 may generate forecast value matrix 528 based on the set of target data instances (e.g., and/or true value matrix 504) and the set of historical data instances (e.g., and/or historical true value matrix 516). In some non-limiting embodiments or aspects, when generating the forecast value matrix, anomaly detection system 502 may provide the historical true value matrix (e.g. historical true value matrix 516) as an input to a dilated convolutional neural network (CNN). In some non-limiting embodiments or aspects, anomaly detection system 502 may provide the historical true value matrix as an input to the dilated CNN to generate an output of the dilated CNN (e.g., multi-scale hidden representation 522). In some non-limiting embodiments or aspects, when generating the forecast value matrix (e.g., forecast value matrix 528), anomaly detection system 502 may generate the forecast value matrix based on the output of the dilated CNN. For example, anomaly detection system 502 may generate forecast value matrix 528 based on multi-scale hidden representation 522, where multi-scale hidden representation 522 is an output of the dilated CNN.

In some non-limiting embodiments or aspects, anomaly detection system 502 may generate an output of the dilated CNN (e.g., multi-scale hidden representation 522) based on the following equation:

$$( F {*}_{ℓ} k ) ( p ) = {\sum }_{s + ℓ t = p} F ( s ) k ( t )$$

where F is a discrete function, k is a convolution kernel, [symbol] is a dilation factor, and [symbol] is a dilated convolution operator. In this way, anomaly detection system 502 may apply different dilation factors to obtain multi-scale information without losing resolution. For example, anomaly detection system 502 may apply a 3-layer dilated CNN with dilation factors 1, 3, and 5 and respective channel numbers 32, 64, and 128 to obtain a deep hidden representation (e.g., multi-scale hidden representation 522). Anomaly detection system 502 may apply a rectangular kernel (3, 1) for each layer to limit multi-scale aggregation over the time dimension rather than the feature dimension. Anomaly detection system 502 may decode the hidden representation (e.g., multi-scale hidden representation 522) to forecast the target window segments of data points (e.g., to forecast true value matrix 504 and/or to generate forecast value matrix 528).

In some non-limiting embodiments or aspects, anomaly detection system 502 may generate a forecast frequency matrix. For example, anomaly detection system 502 may generate forecast frequency matrix 526 based on the set of target data instances and the set of historical data instances (e.g., based on true value matrix 504, historical true value matrix 516, and/or based on true value input matrix 512). In some non-limiting embodiments or aspects, when generating the forecast frequency matrix, anomaly detection system 502 may generate a sequence of window segments (e.g., sequence of window segments 514 and/or frequency matrices 520) based on the historical true value matrix (e.g., based on true value matrix 504, historical true value matrix 516, and/or based on true value input matrix 512). In some non-limiting embodiments or aspects, anomaly detection system 502 may generate sequence of window segments 514 based on true value matrix 504, historical true value matrix 516, and/or true value input matrix 512. In some non-limiting embodiments or aspects, anomaly detection system 502 may generate frequency matrices 520 based on sequence of window segments 514. In some non-limiting embodiments or aspects, when generating the forecast frequency matrix, anomaly detection system 502 may generate a plurality of correlation matrices (e.g., correlation matrices 518) based on cosine similarity scores of the sequence of window segments.

In some non-limiting embodiments or aspects, when generating the forecast frequency matrix, anomaly detection system 502 may provide the plurality of correlation matrices as an input to a convolutional long short-term memory (ConvLSTM) neural network. In some non-limiting embodiments or aspects, anomaly detection system 502 may provide the plurality of correlation matrices as an input to the ConvLSTM neural network to generate an output of the ConvLSTM neural network (e.g., forecast correlation matrix 524 and/or forecast frequency matrix 520). In some non-limiting embodiments or aspects, anomaly detection system 502 may provide the output of the ConvLSTM neural network as an input to an attention mechanism to generate an output of the attention mechanism.

In some non-limiting embodiments or aspects, anomaly detection system 502 may generate a forecast correlation matrix. For example, anomaly detection system 502 may generate forecast correlation matrix 524 based on the set of target data instances and the set of historical data instances (e.g., based on true value matrix 504, historical true value matrix 516, and/or based on true value input matrix 512). In some non-limiting embodiments or aspects, when generating the forecast correlation matrix, anomaly detection system 502 may generate a sequence of window segments (e.g., sequence of window segments 514 and/or correlation matrices 518) based on the historical true value matrix. In some non-limiting embodiments or aspects, anomaly detection system 502 may generate sequence of window segments 514 based on true value matrix 504, historical true value matrix 516, and/or true value input matrix 512. In some non-limiting embodiments or aspects, anomaly detection system 502 may generate correlation matrices 518 based on sequence of window segments 514. In some non-limiting embodiments or aspects, when generating the forecast correlation matrix, anomaly detection system 502 may generate a plurality of frequency matrices (e.g., correlation matrices 518 and/or frequency matrices 520) based on a discrete Fourier transform of the sequence of window segments. In some non-limiting embodiments or aspects, the discrete Fourier transform may be based on the following equation:

$${ξ}_{j} = \frac{1}{k} {\sum }_{ℓ = 0}^{k - 1} {x}_{l} {e}^{2 π ij ℓ / k} , j = 1 , 2 , … , k$$

where i is an imaginary unit. In this way, anomaly detection system 502 may generate a plurality of frequency matrices \vec{ξ}={ξ₁, ξ₂, . . . , ξₖ} (e.g., frequency matrices 520) based on the discrete Fourier transform of the sequence of window segments. In some non-limiting embodiments or aspects, anomaly detection system 502 may generate a plurality of correlation matrices (e.g., correlation matrices 518) based on a discrete Fourier transform of the sequence of window segments.

In some non-limiting embodiments or aspects, when generating the forecast correlation matrix, anomaly detection system 502 may provide the plurality of frequency matrices (e.g., frequency matrices 520) as an input to a ConvLSTM neural network. In some non-limiting embodiments or aspects, anomaly detection system 502 may provide the plurality of frequency matrices as an input to the ConvLSTM neural network to generate an output of the ConvLSTM neural network. In some non-limiting embodiments or aspects, anomaly detection system 502 may provide the output of the ConvLSTM neural network as an input to an attention mechanism to generate an output of the attention mechanism. In some non-limiting embodiments or aspects, when generating the forecast correlation matrix, anomaly detection system 502 may generate the forecast correlation matrix based on the output of the attention mechanism.

In some non-limiting embodiments or aspects, when generating the forecast correlation matrix, anomaly detection system 502 may provide the plurality of correlation matrices (e.g., correlation matrices 518) as an input to a ConvLSTM neural network. In some non-limiting embodiments or aspects, anomaly detection system 502 may provide the plurality of correlation matrices as an input to the ConvLSTM neural network to generate an output of the ConvLSTM neural network. In some non-limiting embodiments or aspects, anomaly detection system 502 may provide the output of the ConvLSTM neural network as an input to an attention mechanism to generate an output of the attention mechanism. In some non-limiting embodiments or aspects, when generating the forecast correlation matrix (e.g., forecast correlation matrix 524), anomaly detection system 502 may generate the forecast correlation matrix based on the output of the attention mechanism.

In some non-limiting embodiments or aspects, the ConvLSTM neural network may be formulated based on the following equations:

iₜ=σ(Wₛᵢ*Sₜ+Wₕᵢ*Hₜ₋₁+W_{ci}∘Cₜ₋₁+bᵢ)

fₜ=σ(W_{sf}*Sₜ+W_{hf}*Hₜ₋₁+W_{cf}∘Cₜ₋₁+b_{f})

Cₜ=fₜ∘Cₜ₋₁+iₜ∘ tanh(W_{sc}*Sₜ+W_{hc}*Hₜ₋₁+b_{c})

oₜ=σ(Wₛₒ*Sₜ+Wₕₒ*Hₜ₋₁+W_{co}∘Cₜ+bₒ)

Hₜ=oₜ∘ tanh(Cₜ)

where iₜ is an input gate, fₜ is a forget gate, oₜ is an output gate, Cₜ is a cell state, Hₜ is a hidden state, W is a window segment of data points, Sₜ is the true correlation matrix, * is a convolution operator, ∘ is a Hadamard product, and σ(⋅) is a sigmoid function.

In some non-limiting embodiments or aspects, anomaly detection system 502 may apply an attention mechanism when generating the output of the attention mechanism. Anomaly detection system 502 may apply the attention mechanism based on the following equation:

$${H}_{t}^{*} = {\sum }_{i = t - k}^{t} {c}_{i} {H}_{i} , {c}_{i} = \frac{exp 〈 vet ( {H}_{i} ) , vet ( {H}_{t} ) 〉}{{\sum }_{j = t - k}^{t} exp 〈 vet ( {H}_{j} ) , vet ( {H}_{t} ) 〉}$$

where vec(⋅) is a matrix flattened into a vector, [symbol] ⋅, ⋅ [symbol] is an inner product, H*ₜ is a representation for a window t. In some non-limiting embodiments or aspects, anomaly detection system 502 may project the representation for the window t into a lower dimensional space and anomaly detection system 502 may apply a fully-connected layer to generate a forecast correlation matrix (e.g., forecast correlation matrix 524).

In some non-limiting embodiments or aspects, anomaly detection system 502 may determine an amount of forecasting error. For example, anomaly detection system 502 may determine the amount of forecasting error between the forecast value matrix, the forecast frequency matrix, and the forecast correlation matrix using forecasting error engine 530. In some non-limiting embodiments or aspects, anomaly detection system 502 may determine the amount of forecasting error between true value matrix 504, true frequency matrix 508, and true correlation matrix 506.

In some non-limiting embodiments or aspects, when determining the amount of forecasting error, anomaly detection system 502 may concatenate the true value matrix, the true frequency matrix, and the true correlation matrix to generate a forecasting input matrix. For example, anomaly detection system 502 may concatenate true value matrix 504, true frequency matrix 508, and true correlation matrix 506 to generate forecasting input matrix 510. In some non-limiting embodiments or aspects, when determining the amount of forecasting error, anomaly detection system 502 may concatenate the forecast value matrix, the forecast frequency matrix, and the forecast correlation matrix to generate a forecasting output matrix. For example, anomaly detection system 502 may concatenate forecast value matrix 528, forecast frequency matrix 526, and forecast correlation matrix 524 to generate forecasting output matrix 532. In some non-limiting embodiments or aspects, when determining the amount of forecasting error, anomaly detection system 502 may determine the amount of forecasting error based on forecasting input matrix 510 and forecasting output matrix 532 using forecasting error engine 530.

In some non-limiting embodiments or aspects, when determining the amount of forecasting error, anomaly detection system 502 may determine a measure of loss associated with a forecasting error mean for batches of input data instances of the dataset of the plurality of data instances. In some non-limiting embodiments or aspects, anomaly detection system 502 may determine the measure of loss associated with a forecasting error mean based on the forecasting input matrix (e.g., forecasting input matrix 510) and the forecasting output matrix (e.g., forecasting output matrix 532).

In some non-limiting embodiments or aspects, anomaly detection system 502 may determine a measure of loss associated with a forecasting error mean for batches of input data instances of the dataset of the plurality of data instances using forecasting error engine 530. In some non-limiting embodiments or aspects, forecasting error engine 530 may determine a measure of loss associated with a forecasting error mean based on the following equation:

$${ℓ}_{1} = \frac{1}{b} {\sum }_{i = 1}^{b} {‖ {Y}_{i} - {\hat{Y}}_{t} ‖}_{2}^{2}$$

where b is a batch size, Yᵢ=[Sᵢ; Fᵢ; Wᵢ] is a concatenation of the true correlation matrix, the true frequency matrix, and the true value matrix at a time step i, and Ŷᵢ=[Ŝᵢ; \hat{F}ᵢ; Ŵᵢ] is a concatenation of the forecast correlation matrix, the forecast frequency matrix, and the forecast value matrix at a time step i.

In some non-limiting embodiments or aspects, when determining the amount of forecasting error, anomaly detection system 502 may determine a measure of loss associated with a variance of forecasting error for each batch of input data instances of the dataset of the plurality of data instances. In some non-limiting embodiments or aspects, anomaly detection system 502 may determine the measure of loss associated with a variance of forecasting error based on the forecasting input matrix and the forecasting output matrix.

In some non-limiting embodiments or aspects, anomaly detection system 502 may determine a measure of loss associated with a variance of forecasting error for each batch of input data instances of the dataset of the plurality of data instances using forecasting error engine 530. In some non-limiting embodiments or aspects, forecasting error engine 530 may determine a measure of loss associated with a variance of forecasting error based on the following equation:

$${ℓ}_{2} = \frac{1}{n b} {\sum }_{i = 1}^{b} {z}_{i}^{T} {z}_{i} , {z}_{i} = {\hat{Y}}_{i} - \frac{1}{b - 1} {\sum }_{j \neq i} \hat{{Y}_{j}}$$

where

$$n = m + k + \frac{k}{2}$$

is a number of columns of Ŷᵢ, b is a batch size, T is a total number of time steps, i is a time step (e.g., row of a matrix), and j is an index of a feature (e.g., column of a matrix). In this way, anomaly detection system 502 may generate a measure of loss associated with a variance of forecasting error [symbol] ₂ which may allow anomaly detection system 502 to obtain a compact representation that is more sensitive to anomalies, thus improving the capability of anomaly detection system 502 to detect anomalies.

In some non-limiting embodiments or aspects, when determining the amount of forecasting error, anomaly detection system 502 may determine the amount of forecasting error based on the measure of loss associated with a forecasting error mean for batches of data instances. Additionally or alternatively, anomaly detection system 502 may determine the amount of forecasting error based on the measure of loss associated with the variance of forecasting error for each batch of data instances. For example, anomaly detection system 502 may determine the amount of forecasting error based on the measure of loss associated with a forecasting error mean for batches of data instances and the measure of loss associated with the variance of forecasting error for each batch of data instances using forecasting error engine 530.

In some non-limiting embodiments or aspects, anomaly detection system 502 may determine the amount of forecasting error. In some non-limiting embodiments or aspects, forecasting error engine 530 may determine the amount of forecasting error based on the following equation:

[symbol]

=f( [symbol] ₁, [symbol] ₂)=(ϵ+ [symbol] ₂)· [symbol] ₁

where ϵ is a small positive constant (e.g., ϵ=10⁻⁵), [symbol] ₁ is the measure of loss associated with a forecasting error mean for batches of input data instances of the dataset of the plurality of data instances, and [symbol] ₂ is the measure of loss associated with a variance of forecasting error for each batch of input data instances of the dataset of the plurality of data instances. In this way, anomaly detection system 502 may determine the amount of forecasting error without needing to fine-tune weights, thus improving the efficiency of the training process. In addition, anomaly detection system 502 may determine the amount of forecasting error while scaling the loss values with the order of change of the measure of loss associated with a forecasting error mean and the measure of loss associated with a variance of forecasting error, thus allowing anomaly detection system 502 to emphasize each measure of loss to the same level regardless of the scale of each measure of loss. In this way, anomaly detection system 502 may improve the performance and accuracy of detecting an anomaly.

In some non-limiting embodiments or aspects, anomaly detection system 502 may determine whether the amount of forecasting error corresponds to an anomaly (e.g., anomalous event). For example, anomaly detection system 502 may determine whether the amount of forecasting error corresponds to an anomalous event associated with the dataset of the plurality of data instances. In some non-limiting embodiments or aspects, when determining whether the amount of forecasting error corresponds to an anomalous event associated with the dataset of the plurality of data instances, anomaly detection system 502 may determine whether the amount of forecasting error satisfies a threshold value of forecasting error. In some non-limiting embodiments or aspects, when determining whether the amount of forecasting error corresponds to an anomalous event associated with the dataset of the plurality of data instances, anomaly detection system 502 may determine whether the dataset of the plurality of data instances includes an anomalous event based on determining whether the amount of forecasting error satisfies the threshold value of forecasting error.

Although the present disclosure has been described in detail for the purpose of illustration based on what is currently considered to be the most practical and preferred embodiments or aspects, it is to be understood that such detail is solely for that purpose and that the present disclosure is not limited to the disclosed embodiments or aspects, but, on the contrary, is intended to cover modifications and equivalent arrangements that are within the spirit and scope of the appended claims. For example, it is to be understood that the present disclosure contemplates that, to the extent possible, one or more features of any embodiment can be combined with one or more features of any other embodiment. Additional details regarding non-limiting embodiments or aspects of the present disclosure may be found in the attached Appendix. The Appendix includes additional details regarding systems, methods, and computer program products for detecting an anomaly in a multivariate time series according to non-limiting embodiments or aspects.

What is claimed is:

1. A system for detecting an anomaly in a multivariate time series, the system comprising:
at least one processor programmed or configured to:
receive a dataset of a plurality of data instances, wherein each data instance comprises a time series of data points;
determine a set of target data instances based on the dataset, wherein each target data instance of the set of target data instances is associated with a first time period;
determine a set of historical data instances based on the dataset, wherein each historical data instance of the set of historical data instances is associated with a second time period, wherein the second time period is prior to the first time period;
generate, based on the set of target data instances, a true value matrix, a true frequency matrix, and a true correlation matrix;
generate a forecast value matrix based on the set of target data instances and the set of historical data instances;
generate a forecast frequency matrix based on the set of target data instances and the set of historical data instances;
generate a forecast correlation matrix based on the set of target data instances and the set of historical data instances;
determine an amount of forecasting error, wherein when determining the amount of forecasting error, the at least one processor is programmed or configured to determine the amount of forecasting error between:
the forecast value matrix, the forecast frequency matrix, and the forecast correlation matrix, and
the true value matrix, the true frequency matrix, and the true correlation matrix; and
determine whether the amount of forecasting error corresponds to an anomalous event associated with the dataset of the plurality of data instances.

2. The system of claim 1, wherein, when determining whether the amount of forecasting error corresponds to an anomalous event associated with the dataset of the plurality of data instances, the at least one processor is programmed or configured to:
determine whether the amount of forecasting error satisfies a threshold value of forecasting error; and
determine whether the dataset of the plurality of data instances includes an anomalous event based on determining whether the amount of forecasting error satisfies the threshold value of forecasting error.

3. The system of claim 1, wherein when determining the amount of forecasting error, the at least one processor is programmed or configured to:
concatenate the true value matrix, the true frequency matrix, and the true correlation matrix to generate a forecasting input matrix;
concatenate the forecast value matrix, the forecast frequency matrix, and the forecast correlation matrix to generate a forecasting output matrix; and
determine the amount of forecasting error based on the forecasting input matrix and the forecasting output matrix.

4. The system of claim 3, wherein when determining the amount of forecasting error, the at least one processor is programmed or configured to:
determine a measure of loss associated with a forecasting error mean for batches of input data instances of the dataset of the plurality of data instances based on the forecasting input matrix and the forecasting output matrix;
determine a measure of loss associated with a variance of forecasting error for each batch of input data instances of the dataset of the plurality of data instances based on the forecasting input matrix and the forecasting output matrix; and
determine the amount of forecasting error based on the measure of loss associated with a forecasting error mean for batches of data instances and the measure of loss associated with the variance of forecasting error for each batch of data instances.

5. The system of claim 1, wherein, when generating the true value matrix, the true frequency matrix, and the true correlation matrix, the at least one processor is programmed or configured to:
generate the true value matrix based on a number of time series of data points in the set of target data instances and a number of time steps in a target window segment of data points;
generate the true frequency matrix based on a discrete Fourier transform of the true value matrix; and
generate the true correlation matrix based on cosine similarity scores between a plurality of time series of data points of the plurality of data instances.

6. The system of claim 1, wherein the at least one processor is further programmed or configured to:
generate a historical true value matrix based on a number of time series of data points in the set of target data instances and a number of time steps in a target window segment of data points.

7. The system of claim 6, wherein, when generating the forecast value matrix, the at least one processor is programmed or configured to:
provide the historical true value matrix as an input to a dilated convolutional neural network (CNN) to generate an output of the dilated CNN; and
generate the forecast value matrix based on the output of the dilated CNN.

8. The system of claim 6, wherein, when generating the forecast frequency matrix, the at least one processor is programmed or configured to:
generate a sequence of window segments based on the historical true value matrix;
generate a plurality of correlation matrices based on cosine similarity scores of the sequence of window segments;
provide the plurality of correlation matrices as an input to a convolutional long short-term memory (ConvLSTM) neural network to generate an output of the ConvLSTM neural network;
provide the output of the ConvLSTM neural network as an input to an attention mechanism to generate an output of the attention mechanism; and
generate the forecast frequency matrix based on the output of the attention mechanism.

9. The system of claim 6, wherein, when generating the forecast correlation matrix, the at least one processor is programmed or configured to:
generate a sequence of window segments based on the historical true value matrix;
generate a plurality of frequency matrices based on a discrete Fourier transform of the sequence of window segments;
provide the plurality of frequency matrices as an input to a convolutional long short-term memory (ConvLSTM) neural network to generate an output of the ConvLSTM neural network;
provide the output of the ConvLSTM neural network as an input to an attention mechanism to generate an output of the attention mechanism; and
generate the forecast correlation matrix based on the output of the attention mechanism.

10. A method for detecting an anomaly in a multivariate time series, the method comprising:
receiving, with at least one processor, a dataset of a plurality of data instances, wherein each data instance comprises a time series of data points;
determining, with the at least one processor, a set of target data instances based on the dataset, wherein each target data instance of the set of target data instances is associated with a first time period;
determining, with the at least one processor, a set of historical data instances based on the dataset, wherein each historical data instance of the set of historical data instances is associated with a second time period, wherein the second time period is prior to the first time period;
generating, with the at least one processor and based on the set of target data instances, a true value matrix, a true frequency matrix, and a true correlation matrix;
generating, with the at least one processor, a forecast value matrix based on the set of target data instances and the set of historical data instances;
generating, with the at least one processor, a forecast frequency matrix based on the set of target data instances and the set of historical data instances;
generating, with the at least one processor, a forecast correlation matrix based on the set of target data instances and the set of historical data instances;
determining, with the at least one processor, an amount of forecasting error, wherein determining the amount of forecasting error comprises determining the amount of forecasting error between:
the forecast value matrix, the forecast frequency matrix, and the forecast correlation matrix, and
the true value matrix, the true frequency matrix, and the true correlation matrix; and
determining, with the at least one processor, whether the amount of forecasting error corresponds to an anomalous event associated with the dataset of the plurality of data instances.

11. The method of claim 10, wherein determining whether the amount of forecasting error corresponds to an anomalous event associated with the dataset of the plurality of data instances comprises:
determining whether the amount of forecasting error satisfies a threshold value of forecasting error; and
determining whether the dataset of the plurality of data instances includes an anomalous event based on determining whether the amount of forecasting error satisfies the threshold value of forecasting error.

12. The method of claim 10, wherein determining the amount of forecasting error comprises:
concatenating the true value matrix, the true frequency matrix, and the true correlation matrix to generate a forecasting input matrix;
concatenating the forecast value matrix, the forecast frequency matrix, and the forecast correlation matrix to generate a forecasting output matrix; and
determining the amount of forecasting error based on the forecasting input matrix and the forecasting output matrix.

13. The method of claim 12, wherein determining the amount of forecasting error comprises:
determining a measure of loss associated with a forecasting error mean for batches of input data instances of the dataset of the plurality of data instances based on the forecasting input matrix and the forecasting output matrix;
determining a measure of loss associated with a variance of forecasting error for each batch of input data instances of the dataset of the plurality of data instances based on the forecasting input matrix and the forecasting output matrix; and
determining the amount of forecasting error based on the measure of loss associated with a forecasting error mean for batches of data instances and the measure of loss associated with the variance of forecasting error for each batch of data instances.

14. The method of claim 10, wherein generating the true value matrix, the true frequency matrix, and the true correlation matrix comprises:
generating the true value matrix based on a number of time series of data points in the set of target data instances and a number of time steps in a target window segment of data points;
generating the true frequency matrix based on a discrete Fourier transform of the true value matrix; and
generating the true correlation matrix based on cosine similarity scores between a plurality of time series of data points of the plurality of data instances.

15. A computer program product for detecting an anomaly in a multivariate time series, the computer program product comprising at least one non-transitory computer-readable medium including one or more instructions that, when executed by at least one processor, cause the at least one processor to:
receive a dataset of a plurality of data instances, wherein each data instance comprises a time series of data points;
determine a set of target data instances based on the dataset, wherein each target data instance of the set of target data instances is associated with a first time period;
determine a set of historical data instances based on the dataset, wherein each historical data instance of the set of historical data instances is associated with a second time period, wherein the second time period is prior to the first time period;
generate, based on the set of target data instances, a true value matrix, a true frequency matrix, and a true correlation matrix;
generate a forecast value matrix based on the set of target data instances and the set of historical data instances;
generate a forecast frequency matrix based on the set of target data instances and the set of historical data instances;
generate a forecast correlation matrix based on the set of target data instances and the set of historical data instances;
determine an amount of forecasting error, wherein when determining the amount of forecasting error, the at least one processor is programmed or configured to determine the amount of forecasting error between:
the forecast value matrix, the forecast frequency matrix, and the forecast correlation matrix, and
the true value matrix, the true frequency matrix, and the true correlation matrix; and
determine whether the amount of forecasting error corresponds to an anomalous event associated with the dataset of the plurality of data instances.

16. The computer program product of claim 15, wherein the one or more instructions that cause the at least one processor to determine whether the amount of forecasting error corresponds to an anomalous event associated with the dataset of the plurality of data instances cause the at least one processor to:
determine whether the amount of forecasting error satisfies a threshold value of forecasting error; and
determine whether the dataset of the plurality of data instances includes an anomalous event based on determining whether the amount of forecasting error satisfies the threshold value of forecasting error.

17. The computer program product of claim 15, wherein the one or more instructions that cause the at least one processor to determine the amount of forecasting error cause the at least one processor to:
concatenate the true value matrix, the true frequency matrix, and the true correlation matrix to generate a forecasting input matrix;
concatenate the forecast value matrix, the forecast frequency matrix, and the forecast correlation matrix to generate a forecasting output matrix; and
determine the amount of forecasting error based on the forecasting input matrix and the forecasting output matrix;
wherein the one or more instructions that cause the at least one processor to determine the amount of forecasting error cause the at least one processor to:
determine a measure of loss associated with a forecasting error mean for batches of input data instances of the dataset of the plurality of data instances based on the forecasting input matrix and the forecasting output matrix;
determine a measure of loss associated with a variance of forecasting error for each batch of input data instances of the dataset of the plurality of data instances based on the forecasting input matrix and the forecasting output matrix; and
determine the amount of forecasting error based on the measure of loss associated with a forecasting error mean for batches of data instances and the measure of loss associated with the variance of forecasting error for each batch of data instances.

18. The computer program product of claim 15, wherein the one or more instructions that cause the at least one processor to generate the true value matrix, the true frequency matrix, and the true correlation matrix cause the at least one processor to:
generate the true value matrix based on a number of time series of data points in the set of target data instances and a number of time steps in a target window segment of data points;
generate the true frequency matrix based on a discrete Fourier transform of the true value matrix; and
generate the true correlation matrix based on cosine similarity scores between a plurality of time series of data points of the plurality of data instances.

19. The computer program product of claim 15, wherein the one or more instructions further cause the at least one processor to:
generate a historical true value matrix based on a number of time series of data points in the set of target data instances and a number of time steps in a target window segment of data points;
wherein the one or more instructions that cause the at least one processor to generate the forecast value matrix cause the at least one processor to:
provide the historical true value matrix as an input to a dilated convolutional neural network (CNN) to generate an output of the dilated CNN; and
generate the forecast value matrix based on the output of the dilated CNN.

20. The computer program product of claim 19, wherein the one or more instructions that cause the at least one processor to generate the forecast frequency matrix cause the at least one processor to:
generate a sequence of window segments based on the historical true value matrix;
generate a plurality of correlation matrices based on cosine similarity scores of the sequence of window segments;
provide the plurality of correlation matrices as an input to a convolutional long short-term memory (ConvLSTM) neural network to generate an output of the ConvLSTM neural network;
provide the output of the ConvLSTM neural network as an input to an attention mechanism to generate an output of the attention mechanism; and
generate the forecast frequency matrix based on the output of the attention mechanism.
